(19) United States
(12) Patent Application Publication
(10) Pub. No.: US 2026/0260586 A1
(43) Pub. Date: Sep. 3, 2026

(54) MEDIUM

(71) Applicant: BROTHER KOGYO KABUSHIKI KAISHA, Nagoya (JP)

(72) Inventors: Shiori MIZUTANI, Chiryu (JP); Chie NAKASHIMA, Nagoya (JP); Shohei TSUCHIMORI, Nagoya (JP)

(21) Appl. No.: 19/551,921

(22) Filed: Feb. 27, 2026

(30) Foreign Application Priority Data
Feb. 28, 2025 (JP) 2025-032228
May 7, 2025 (JP) 2025-077377

(51) Int. Cl. G09F 3/10; B41J 3/407; G09F 3/02

(52) U.S. Cl. CPC G09F 3/10; B41J 3/4075; G09F 2003/0269

(57) ABSTRACT

A medium includes at least one base material including a printing surface and an adhesive layer, and a release liner affixed to the adhesive layer. The at least one base material includes a first portion and a second portion. The second portion is aligned with the first portion in a first direction and connected to the first portion. The second portion includes a base portion and a first fold portion. The base portion is aligned with the first portion in the first direction and connected to the first portion. The first fold portion is aligned with the base portion in a second direction, and connected to the base portion. The base portion is shorter than the first portion in the second direction. The second portion includes at least one recess recessed in a thickness direction of the base material or at least one cut extending in the thickness direction.

### REFERENCE TO RELATED APPLICATIONS

This application claims priority from Japanese Patent Application No. 2025-032228 filed on February 28, 2025, and Japanese Patent Application No. 2025-077377 filed on May 7, 2025. The entire contents of the foregoing priority applications are incorporated herein by reference.

### BACKGROUND ART

Known laminated tag is formed by folding a label. The label includes a display part, an attaching part and a cut. Characters, such as a commodity name, are printed on the display part. The attaching part is connected to a longitudinal end of the display part. Adhesive is applied on back surfaces of the display part and the attaching part. The cut extends in a width direction of the attaching part along a boundary between the attaching part and the display part. The cut has a length that is at least half of an entire width of the attaching part. When a user of the tag attaches the tag to an object such as a ring, the user first folds the attaching part in two in the width direction about an end of the cut such that adhesive back surfaces of overlapping portions of the attaching part are affixed or bonded to each other. The user then disposes the attaching part around the object. The user then folds the display part in two in the width direction such that adhesive back surfaces of overlapping portions of the display part are affixed or bonded to each other, with an end portion of the attaching part sandwiched between these portions. In this manner, the user can attach the known laminated tag to the object without the back surfaces of the display part and the attaching part sticking to the object.

### SUMMARY

Since the attaching part of the above-described known tag includes the overlapping portions that are affixed to each other with the adhesive applied on their back surfaces, the attaching part may become too rigid. As a result, the affixed overlapping portions of the display part may be separated from each other.

Embodiments of the broad principles derived herein provide a medium that includes a base material having a printing surface and an adhesive layer, and a release liner affixed to the adhesive layer and that contributes to reducing a possibility that affixed portions of the base material are separated from each other due to a restoring force of a portion of the at least one base material disposed around an object.

Embodiments provide a medium that includes at least one base material including a printing surface and an adhesive layer, and a release liner affixed to the adhesive layer. The at least one base material includes a first portion and a second portion. The second portion is aligned with the first portion in a first direction and connected to the first portion. The second portion includes a base portion and a first fold portion. The base portion is aligned with the first portion in the first direction and connected to the first portion. The first fold portion is aligned with the base portion in a second direction, which is perpendicular to the first direction, and connected to the base portion. The base portion is shorter than the first portion in the second direction. The second portion includes at least one recess recessed in a thickness direction of the least one base material or at least one cut extending in the thickness direction. The at least one recess or the at least one cut in the second portion of the medium contributes to reducing a restoring force of the second portion, which is disposed around an object with the base portion and the first fold portion affixed together, as compared to a medium including the second portion without any cut or recess. The at least one recess or the at least one cut in the second portion of the medium, thus contributes to reducing a possibility that affixed portions separate from each other due to the restoring force of the second portion disposed around the object.

Embodiments further provide a medium that includes a base material including a printing surface and an adhesive layer and a release liner affixed to the adhesive layer. The base material includes a first portion and a second portion. The second portion is aligned with the first portion in a first direction and connected to the first portion. The second portion includes a base portion and a fold portion. The base portion is aligned with the first portion in the first direction and connected to the first portion. The fold portion is aligned with the base portion in a second direction, which is perpendicular to the first direction, and connected to the base portion. The base portion is shorter than the first portion in the second direction. The second portion has a lower rigidity than the first portion. The at least one recess or the at least one cut in the second portion of the medium contributes to reducing a restoring force of the second portion, which is disposed around an object with the base portion and the first fold portion affixed together, as compared to a medium including the second portion without any cut or recess. The at least one recess or the at least one cut in the second portion of the medium, thus contributes to reducing a possibility that affixed portions separate from each other due to the restoring force of the second portion disposed around the object.

### BRIEF DESCRIPTION OF DRAWINGS

FIG. 1 is a perspective view of a printer with a cover at a closed position, as viewed from an upper right front of the printer.

FIG. 2 is a schematic view of a medium that is conveyed in the printer, as viewed from a side of the printer.

FIG. 3A is a bottom view of the medium. FIG. 3B is a cross-sectional view taken along line D-D in FIG. 3A as viewed in a direction of arrows.

FIG. 4 is a plan view of the medium.

FIGS. 5A, 5B and 5C illustrate exemplary operations for attaching a printed base material to an object.

FIG. 6 illustrates an electrical configuration of the printer.

FIG. 7 is a flowchart of a main processing.

FIG. 8 is a bottom view of a medium.

FIG. 9 is a plan view of the medium.

FIG. 10 is a bottom view of a medium.

FIG. 11 is a bottom view of a medium.

FIG. 12 is a bottom view of a medium.

FIG. 13A is a bottom view of a medium. FIG. 13B is a cross-sectional view taken along line E-E in FIG. 13A as viewed in a direction of arrows.

FIG. 14A is a bottom view of a medium. FIG. 14B is a bottom view of a base material.

FIG. 15 is a table illustrating preferable dimensional ranges and exemplary dimensions of the mediums.

FIG. 16 is a bottom view of a medium.

FIG. 17 is a plan view of the medium.

FIG. 18 is a bottom view of a medium.

FIG. 19 is a plan view of the medium.

FIG. 20 is a bottom view of a medium.

FIGS. 21A, 21B and 21C are bottom views of base material composites.

FIG. 22 is a table illustrating preferable dimensional ranges and exemplary dimensions of the mediums.

### DESCRIPTION

A printer 1 and a medium 6 according to an embodiment of the present disclosure is described below, with reference to the drawings. The drawings are used for describing technical features that may be employed in the present disclosure. Structures of various devices that are shown in the drawings are merely exemplary and thus non-limiting. Left, right, front, rear, up and down shown by arrows in the drawings are used in the following description.

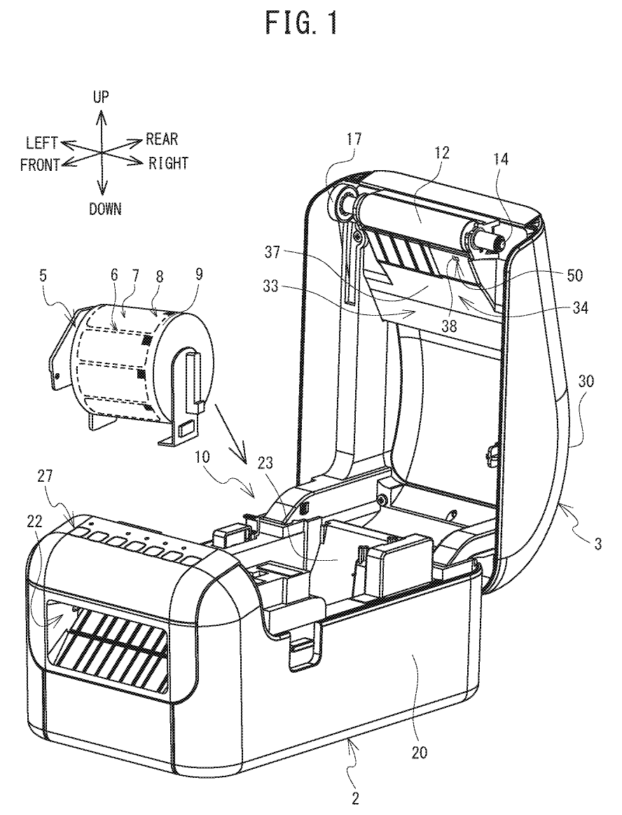

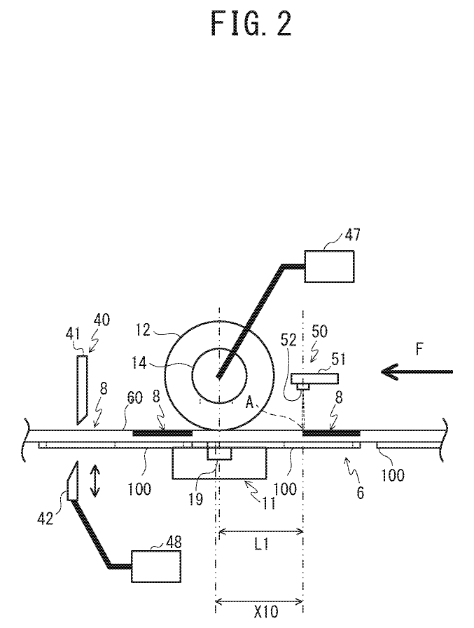

As shown in FIGS. 1 and 2, the printer 1 is a thermal printer for printing on the medium 6. The printer 1 is a mobile printer that can be carried by a user of the printer 1. The printer 1 includes a housing 2, a thermal head 11, a platen roller 12 and a sensor 50.

The housing 2 has a shape of a rectangular box that extends in a front-rear direction. The housing 2 houses or accommodates the thermal head 11, the platen roller 12 and the sensor 50. The housing 2 includes a case 20 and a cover 3. The case 20 is a lower part of the housing 2. The case 20 is generally a rectangular box having an open upper end.

The case 20 includes an output slot 22, a housing wall 23 and a housing space 10. The output slot 22 is disposed through a front wall of the case 20. The housing space 10 is located rearward of the output slot 22. The housing wall 23 extends in an arc from a portion in the vicinity of an upper end of a rear wall of the case 20 such that the housing wall 23 protrudes downward as the housing wall 23 extends forward. The housing space 10 is a space that is defined by the housing wall 23. The housing space 10 is configured to house or accommodate the medium 6. The medium 6 is a tape or a strip, and wound into a roll 5. The roll 5 of the print medium 6 is disposed in the housing space 10. An axial direction of the roll 5 defines a left-right direction. A width direction of the medium 6 also defines the left-right direction.

The case 20 houses the thermal head 11, a cutter 40 and a cutting motor 48. The thermal head 11 is located frontward of the housing space 10. The thermal head 11 is shaped like a plate that extends in the left-right direction. The thermal head 11 includes heating elements 19. The heating elements 19 are disposed at an upper end of the thermal head 11 and are aligned in the left-right direction.

The cutter 40 is disposed between the thermal head 11 and the output slot 22 in a conveyance direction of the medium 6 that is indicated by an arrow F. The conveyance direction may also be referred to a feed direction or a transport direction of the medium 6. In the present embodiment, the medium 6 is conveyed or fed forward above the thermal head 11. The conveyance direction of the medium 6 in the present embodiment is thus a forward direction. An upstream in the conveyance direction corresponds to a rear side in the front-rear direction and a downstream in the conveyance direction corresponds to a front side in the front-rear direction. The cutter 40 includes a fixed blade 41 and a movable blade 42. The fixed blade 41 extends in an up-down direction. The fixed blade 41 is disposed above the medium 6 that is being conveyed.

The movable blade 42 extends in the up-down direction. The movable blade 42 is disposed below the medium 6 that is being conveyed. The movable blade 42 is movable in the up-down direction. The movable blade 42 is coupled to the cutting motor 48. The movable blade 42 is moved upward in response to driving of the cutting motor 48 to cut the medium 6 between the fixed blade 41 and the movable blade 42.

The cover 3 is disposed above the case 20. A lower rear portion of the cover 3 is supported by the case 20 such that the cover 3 is pivotable to an open position and a closed position. As shown in FIG. 1, the cover 3 at the open position opens the housing space 10 or allows the housing space 10 to be open to an outside of the printer 1. The cover 3 at the closed position closes or covers the housing space 10. The structure of the cover 3 is described below with reference to the cover 3 disposed at the closed position.

The cover 3 includes a base material 30 and a holder 33. The base material 30 is a plate member that extends in the front-rear direction. An upper surface of the base material 30 slopes downward as the base material 30 extends forward. The holder 33 includes a container 34. The container 34 is disposed on a lower surface of the base material 30. The container 34 includes a sloping wall 37. The sloping wall 37 defines a lower surface of the container 34.

The cover 3 includes the platen roller 12, a platen gear 17 and a conveyance motor 47. The holder 33 rotatably supports the platen roller 12. The platen roller 12 is a cylindrical member. An axis of the platen roller 12 extends in the left-right direction, i.e., an axial direction of the platen roller 12 is the left-right direction. A rotation shaft 14 extends through the platen roller 12. The rotation shaft 14 extends in the left-right direction. The platen roller 12 is located directly above the thermal head 11 when the cover 3 is at the closed position. The platen roller 12 and the thermal head 11 hold or nip the print medium 6 from above and below.

The platen gear 17 is disposed around a left end of the rotation shaft 14. The platen gear 17 rotates in response to driving of the conveyance motor 47. The platen roller 12 rotates in response to rotation of the platen gear 17. The platen roller 12 thus rotates in response to driving of the conveyance motor 47 about the rotation shaft 14 to thereby convey or feed the print medium 6 while nipping the print medium 6 with the thermal head 11.

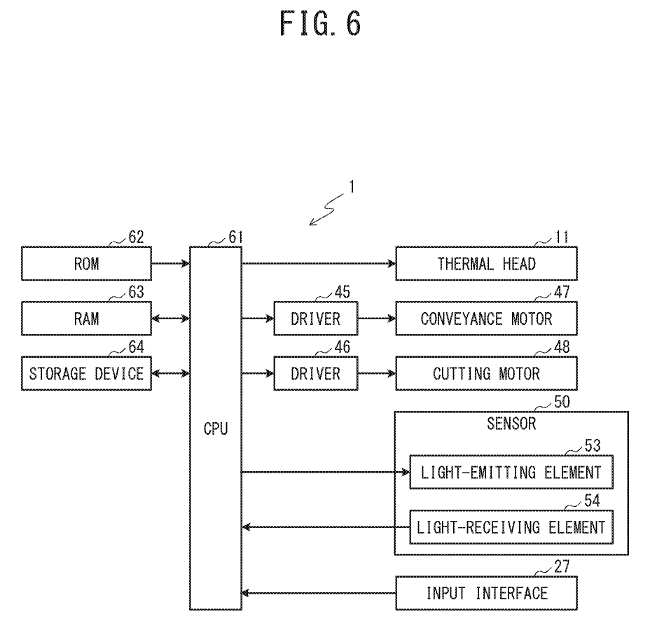

The container 34 houses or accommodates the sensor 50. The sensor 50 is located just behind a right end portion of the platen roller 12. In other words, the sensor 50 is located slightly upstream of the platen roller 12 in the conveyance direction. The sensor 50 includes a circuit board 51 and element section 52. The circuit board 51 is disposed on an upper surface of the sloping wall 37. The element section 52 is disposed on a lower surface of the circuit board 51. The element section 52 is disposed directly above a hole 38 that extends through the sloping wall 37 in the up-down direction. The element section 52 includes a light-emitting element 53 and a light-receiving element 54 shown in FIG. 6. The light-emitting element 53 and the light-receiving element 54 are aligned in the left-right direction. A distance L1 in the conveyance direction between a center of the element section 52 and a center of the platen roller 12 is, for example, 15 millimeters (mm). The light-emitting element 53 emits light through the hole 38 toward an area A directly below the light-emitting element 53. The light-receiving element 54 outputs an electric current in accordance with an amount of light received by the light-receiving element 54 to a CPU 61 shown in FIG. 6.

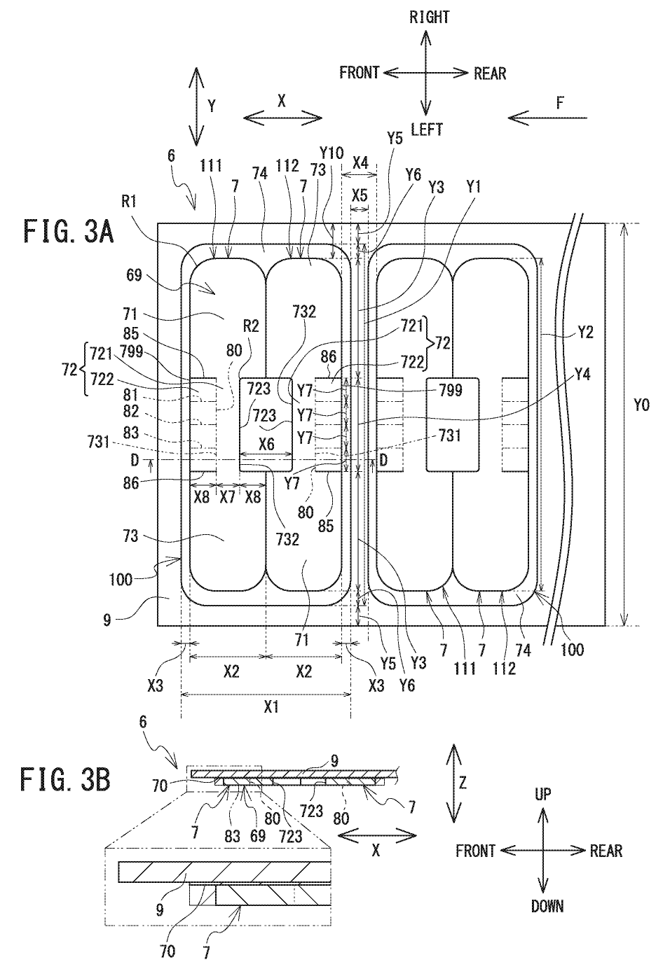

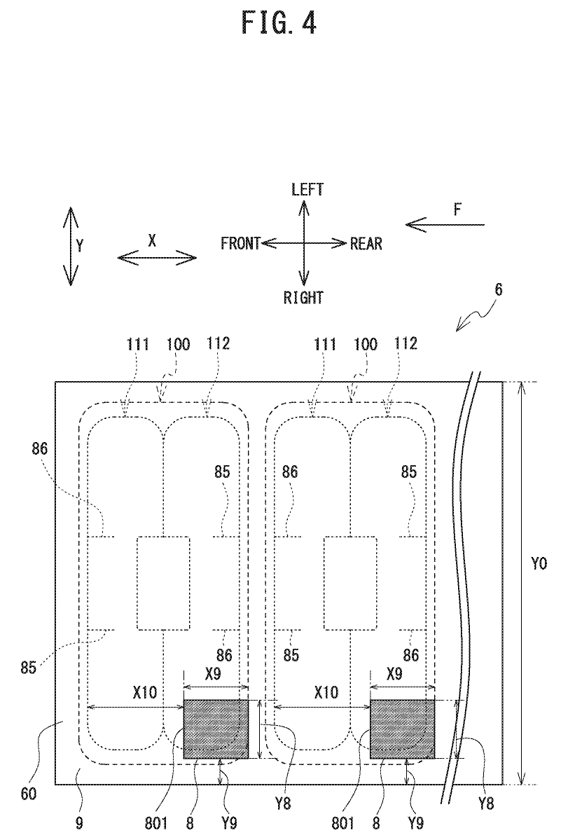

The medium 6 is described below, with reference to FIGS. 3A, 3B and 4. The following description refers to the medium 6 in an orientation in which the medium 6 is held and conveyed between the platen roller 12 and the thermal head 11. Specifically, the medium 6 is conveyed in the conveyance direction in such an orientation that a printing surface 69 of a base material 7 faces downward, i.e., the printing surface 69 of the base material 7 opposes or faces the thermal head 11. It is noted that the base material 7 may also be referred to as a substrate.

As shown in FIG. 3A, the medium 6 includes a release liner 9 and a plurality of base material composites 100. The release liner 9 is an elongated sheet like a tape or strip. A longitudinal direction of the release liner 9 is the front-rear direction. A direction that is perpendicular to the longitudinal direction of the release liner 9 is hereinafter referred to as a first direction. The first direction in the present embodiment is indicated by an arrow Y in FIG. 3A. Specifically, the first direction in the present embodiment is the left-right direction. A length Y0 of the release liner 9 in the first direction is, for example, 66 mm. A color of the release liner 9 is, for example, white.

The base material composites 100 are affixed to the release liner 9. Each of the base material composites 100 has a rectangular shape that is elongated in the first direction. The base material composite 100 is affixed to the release liner 9 such that a center of the base material composite 100 in the first direction coincides with a center of the release liner 9 in the first direction.

A length Y1 of the base material composite 100 in the first direction is shorter than the length Y0 of the release liner 9 in the first direction. The length Y1 is, for example, 62 mm. A length X1 of the base material composite 100 in a second direction is, for example, 29 mm. The second direction is perpendicular to the first direction. The second direction in the present embodiment is indicated by an arrow X in FIG. 3A. Specifically, the second direction in the present embodiment is the front-rear direction.

The base material composite 100 includes a first base material 111, a second base material 112 and a blank space 74. The first base material 111 and the second base material 112 are affixed to the release liner 9 such that the first base material 111 is in contact with the second base material 112 in the second direction. The first base material 111 is located downstream of the second base material 112 in the conveyance direction. When the first base material 111 or the second base material 112 is referred to without specifying which one, the first base material 111 or the second base material 112 is hereinafter simply referred to as the base material 7.

A length Y2 of the base material 7 in the first direction is shorter than the length Y1. The length Y2 is, for example, 57 mm. A length X2 of the base material 7 in the second direction is, for example, 13 mm. A distance X5 between two base material composites 100 that are adjacent to or next to each other in the second direction is, for example, 3 mm. A distance X4 in the second direction between the second base material 112 of a first one of the two adjacent base material composites 100 and the first base material 111 of a second one of the two adjacent base material composites 100 is, for example, 6 mm. It is noted that the second one of the two adjacent base material composites 100 is upstream of the first one of the two adjacent base material composites 100 in the conveyance direction.

The blank space 74 is annular or ring-shaped. In each of the base material composites 100, the blank space 74 surrounds or encircles the first base material 111 and the second base material 112. The blank space 74 serves to protect the first base material 111 and the second base material 112. A distance X3 in the second direction between an edge of the base material 7 in the second direction and an adjacent edge of the blank space 74 in the second direction is, for example, 1.5 mm. More specifically, the distance X3 is a distance in the second direction between a front edge of the first base material 111 and a front edge of the blank space 74. The distance X3 is also a distance in the second direction between a rear edge of the second base material 112 and a rear edge of the blank space 74. A distance Y6 in the first direction between an edge of the base material 7 in the first direction and an adjacent edge of the blank space 74 in the first direction is, for example, 2.5 mm. More specifically, the distance Y6 is a distance in the first direction between a left edge of the base material 7 and a left edge of the blank space 74. The distance Y6 is also a distance in the first direction between a right edge of the base material 7 and a right edge of the blank space 74. A distance Y5 in the first direction between an edge of the release liner 9 in the first direction and an adjacent edge of the blank space 74 in the first direction is, for example, 2 mm. More specifically, the distance Y5 is a distance in the first direction between a left edge of the release liner 9 and the left edge of the blank space 74. The distance Y5 is also a distance in the first direction between a right edge of the release liner 9 and the right edge of the blank space 74. The release liner 9 is exposed around the blank space 74. A distance Y10 in the first direction between an edge of the release liner 9 in the first direction and an adjacent edge of the base material 7 in the first direction is, for example, 4.5 mm. More specifically, the distance Y10 is a distance in the first direction between the left edge of the release liner 9 and the left edge of the base material 7. The distance Y10 is also a distance in the first direction between the right edge of the release liner 9 and the right edge of the base material 7.

As shown in FIGS. 3A and 3B, the base material 7 includes the printing surface 69 and an adhesive layer 70. The adhesive layer 70 is on a surface of the base material 7 that is opposite from the printing surface 69. The base material 7 includes a first portion 71, a second portion 72 and a third portion 73.

The first portion 71 has a rectangular shape that is elongated in the first direction. In the present embodiment, a length Y3 of the first portion 71 in the first direction is, for example, 20.5 mm. The first portion 71 has the length X2 in the second direction. Corners of the first portion 71 are rounded. A radius R1 of curvature of the rounded corners of the first portion 71 is, for example, 4.5 mm.

The second portion 72 is aligned or arranged in line with the first portion 71 in the first direction. The second portion 72 is connected to the first portion 71. The second portion 72 includes a base portion 721 and a fold portion 722. The base portion 721 is aligned or arranged in line with the first portion 71 in the first direction. The base portion 721 is connected to the first portion 71. A length X7 of the base portion 721 in the second direction is shorter than the length X2 of the first portion 71 in the second direction. More specifically, the length X7 of the base portion 721 in the second direction is shorter than a half of the length X2 of the first portion in the second direction. In the present embodiment, the length X7 is, for example, 4 mm.

The fold portion 722 is adjacent to an edge 731, which is a first one of opposite edges 731, 732 of the base portion 721 that are opposite from each other in the second direction. The base material 7 includes a recess 723 that is adjacent to an edge which is a second one of the opposite edges 731, 732 of the base portion 721 in the second direction. The recess 723 is recessed from an edge of the base material 7 in the second direction toward the edge 731 of the base portion 721, i.e., toward the fold portion 722. The edge 732 of the base portion 721 in the second direction defines an edge of the second portion 72 in the second direction. It is noted that the edge 731 of the base portion 721 of the first base material 111 and the edge 731 of the base portion 721 of the second base material 112 face opposite directions. Specifically, the edge 731 of the base portion 721 of the first base material 111, which is located downstream of the second base material 112, faces downstream in the conveyance direction, i.e., forward. In other words, the edge 731 of the base portion 721 of the first base material 111 is a downstream or front edge of the base portion 721. The edge 731 of the base portion 721 of the second base material 112, which is located upstream of the first base material 111, faces upstream of the conveyance direction, i.e., rearward. In other words, the edge 731 of the base portion 721 of the second base material 112 an upstream or rear edge of the base portion 721. Corners of the recess 723 are rounded. A radius R2 of curvature of the rounded corners of the recess 723 is, for example, 0.5 mm. The radius R2 is smaller than the radius R1.

The base portion 721 of the first base material 111 and the base portion 721 of the second base material 112 are disposed between the fold portion 722 of the first base material 111 and the fold portion 722 of the second base material 112 in the second direction. The recess 723 of the first base material 111 and the recess 723 of the second base material 112 are connected to each other in the second direction such that the two recesses 723 together form a rectangular hole. The release liner 9 is exposed in portions of the medium 6 that correspond to the recesses 723 of the first base material 111 and the second base material 112. A distance X6 in the second direction between the base portion 721 of the first base material 111 and the base portion 721 of the second base material 112 is, for example, 9 mm.

The fold portion 722 is aligned or arranged in line with the base portion 721 in the second direction, which is perpendicular to the first direction. The fold portion 722 is connected to the base portion 721. A length X8 of the fold portion 722 in the second direction is longer than the length X7 of the base portion 721 in the second direction. The length X8 is, for example, 4.5 mm. The length X8 in the present embodiment is thus 0.5 mm longer than the length X7. A center of the base portion 721 in the second direction coincides with a center of the base material 7 in the second direction. Therefore, a length or depth of the recess 723 in the second direction is equal to the length X8 of the fold portion 722 in the second direction.

A rigidity of the second portion 72 is lower than a rigidity of the first portion 71. The rigidity of the second portion 72 is lower than a rigidity of the third portion 73. The rigidity may be determined in accordance with "JIS (Japanese Industrial Standards) 7171: A method for determining the flexural properties of plastics".

The second portion 72 of the present embodiment includes at least one recess that is recessed or extends in a thickness direction of the base material 7 or at least one cut that extends in the thickness direction of the base material 7. The thickness direction of the base material 7 is indicated by an arrow Z in FIG. 3B. Specifically, the thickness direction of the base material 7 is the up-down direction. The at least one recess or the at least one cut may or may not extend through the base material 7 in the thickness direction. The at least one recess or the at least one cut may be disposed in the base portion 721 or the fold portion 722. The recesses or the cuts may be disposed in both of the base portion 721 and the fold portion 722.

The second portion 72 of the present embodiment includes a plurality of cuts. Specifically, the second portion 72 of the present embodiment includes cuts 81 to 83, i.e., 81, 82 and 83 that are disposed in the fold portion 722. The cuts 81 to 83 extend through the base material 7 in the thickness direction. A longitudinal direction of each of the cuts 81 to 83 is parallel to the second direction. Each of the cuts 81 to 83 is a perforated line. The perforated line may be disposed by a plurality of cuts each having a predetermined length or a plurality of holes that are arranged in line at equal intervals. Each of the cuts 81 to 83 includes linear cuts and ties, each of which is disposed between adjacent two of the linear cuts. The predetermined length of the linear cut is preferably within a range from 0.1 mm to 1.0 mm, inclusive. A length of each of the liner cuts in the perforated lines, i.e., the cuts 81 to 83, is, for example, 0.3 mm. A length of each of the ties in the perforated lines, i.e., the cuts 81 to 83, is, for example, 0.2 mm.

The cut 82 is disposed at a center of the second portion 72 in the first direction. The cut 82 extends along or on a centerline of the second portion 72 in the first direction. The cuts 81 to 83 are equally spaced, by a distance Y7, in the first direction. The cut 81 and the cut 83 are line-symmetric with respect to the cut 82. In the present embodiment, a length Y4 of the second portion 72 in the first direction is shorter than the length Y3 of the first portion 71 in the first direction. The length Y4 of the second portion 72 of the present embodiment in the first direction is, for example, 16 mm. The distance Y7 is, for example, 4 mm.

The medium 6 includes a cut 85 between the fold portion 722 and the first portion 71. The medium 6 also includes a cut 86 between the fold portion 722 and the third portion 73. The cuts 85, 86 linearly extend from a boundary between the base portion 721 and the fold portion 722 to an edge 799, which is one of opposite edges 732, 799 of the second portion 72 in the second direction. The cuts 85, 86 extend through the base material 7 in the thickness direction.

The fold portion 722 and the first portion 71 are separated from each other in the first direction by the cut 85. The fold portion 722 is in contact with the first portion 71 in the first direction. The fold portion 722 and the third portion 73 are separated from each other in the first direction by the cut 86. The fold portion 722 is in contact with the third portion 73 in the first direction.

The medium 6 includes a cut 80 that extends along or on a boundary between the base portion 721 and the fold portion 722. The cut 80 is a perforated line that includes a plurality of cuts extending through the base material 7 in the thickness direction. The cut 80 is disposed in the second portion 72 in order to facilitate folding the base material 7 along the boundary between the fold portion 722 and the base portion 721.

The third portion 73 is aligned or arranged in line with the second portion 72 in the first direction. The third portion 73 is connected to the second portion 72. The base portion 721 of the second portion 72 is shorter than the third portion 73 in the second direction. In the first direction, the second portion 72 is located between the first portion 71 and the third portion 73. The base material 7 is symmetric with respect to a center of the base material 7 in its longitudinal direction, i.e., with respect to a center of the base material 7 in the first direction. The third portion 73 and the first portion 71 are thus line-symmetric to each other with respect to the center of the base material 7 in the first direction.

As shown in FIGS. 2 and 4, the release liner 9 has a plurality of marks 8 on a surface 60 that is opposite from a surface on which the base material composites 100 are affixed. The marks 8 are equally spaced and aligned in the conveyance direction of the medium 6. In the present embodiment, each of the marks 8 is a black rectangle. A length Y8 of the mark 8 in the first direction is, for example, 10 mm. A distance Y9 in the first direction between the mark 8 and an edge of the release liner 9 in the first direction is, for example, 4.5 mm. A length X9 of the mark 8 in the second direction is, for example, 13 mm. A distance X10 in the conveyance direction between a downstream edge 801 of the mark 8 and a downstream edge of the first base material 111 that is disposed downstream of the mark 8 is, for example, 16.5 mm. The distance X10 is longer than the distance L1 in the conveyance direction between the center of the element section 52 of the sensor 50 and the center of the platen roller 12 in the conveyance direction.

Each of the marks 8 corresponds to one of the base material composites 100. An upstream edge of the mark 8 is at a same location as an upstream edge of the corresponding base material composite 100 in the conveyance direction. The mark 8 is disposed between two opposite edges of the corresponding base material composite 100 in the first direction. The mark 8 is offset from or does not overlap a center of the medium 6 in the first direction. While the medium 6 is conveyed by the platen roller 12 in the conveyance direction, the mark 8 passes a location directly below the sensor 50. A size of the mark 8 is sufficiently large, relative to the area A that is exposed to the light from the sensor 50. The mark 8 is utilized in a process of determining a position of the corresponding base material composite 100.

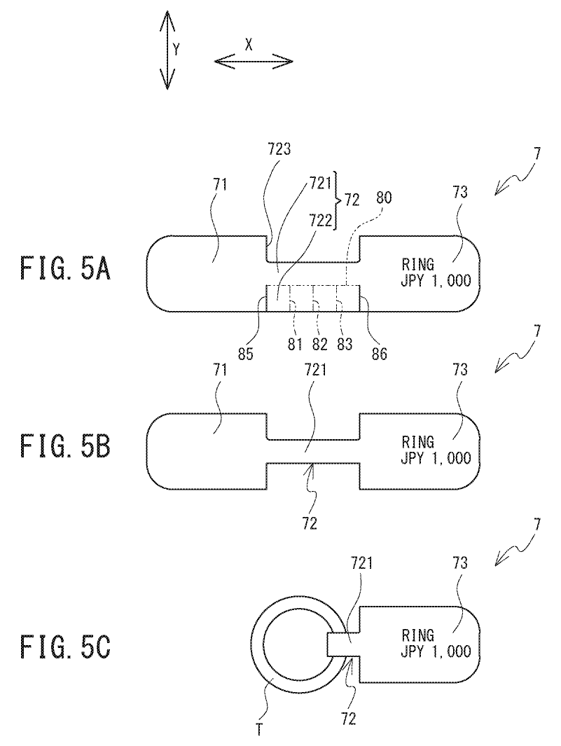

A process of attaching or mounting a printed base material 7 to an object T, with reference to FIGS. 5A to 5C. The object T is not limited to a specific commodity or product. An example of the object T is a ring. The printer 1 is configured to print an image at any location on the printing surface 69 of the base material 7. Specifically, the printer 1 is configured to print an image on at least one of the first portion 71, the second portion 72 or the third portion 73. For example, as shown in FIG. 5A, the printer 1 prints a commodity name "ring" and a price "JPY 1,000" in two columns on the third portion 73 of the base material 7. JPY represents Japanese yen. The user of the medium 6 peels or removes the printed base material 7 from the release liner 9.

As shown in FIG. 5B, the user folds the fold portion 722 along the cut 80 such that the adhesive layer 70 of the fold portion 722 is affixed to the adhesive layer 70 of the base portion 721. The user can easily fold only the fold portion 722 along the cut 80, owing to the cuts 85, 86 of the base material 7. The adhesive layer 70 of the fold portion 722 and the adhesive layer 70 of the base portion 721 are thus bonded together, so that the adhesive layer 70 of the second portion 72 can be prevented from sticking to another member.

As shown in FIG. 5C, the user passes the first portion 71 or the third portion 73 through a hole of the object T, i.e., the ring. The user bends the second portion 72 into a ring such that the adhesive layer 70 of the first portion 71 is affixed to the adhesive layer 70 of the third portion 73. The second portion 72 does not stick to the object T. The adhesive layer 70 of the first portion 71 and the adhesive layer 70 of the third portion 73 are thus bonded together, so that the adhesive layers 70 of the first portion 71 and the third portion 73 can be prevented from sticking to another member. The printed base material 7 is attached to the object T in a manner described above.

In order to remove the base material 7, which is disposed around the object T, from the object T, the user may, for example, cut the second portion 72 by applying a force to the second portion 72. The fold portion 722 of the second portion 72 has the cuts 81 to 83 that extend in the second direction. Owing to the cuts 81 to 83, the user can cut the second portion 72 with relatively small force to remove the base material 7 from the object T.

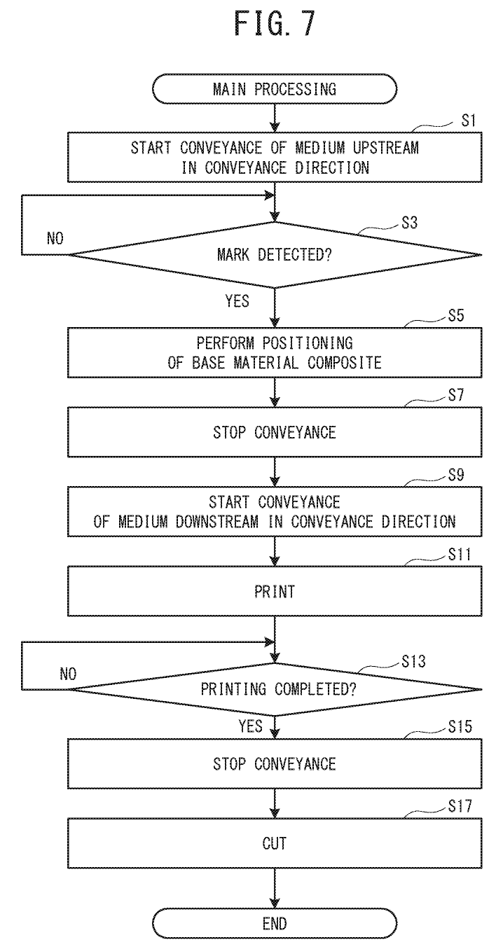

An electric configuration of the printer 1 is described below, with reference to FIG. 7. The printer 1 includes a CPU 61, an ROM 62, an RAM 63, a storage device 64, drivers 45, 46 and an input interface 27. The input interface 27 is hereinafter referred to as an input IF 27. The CPU 61 is configured to control the printer 1. In other words, the CPU 61 serves as a controller of the printer 1. The CPU 61 is connected to the ROM 62, the RAM 63, the storage device 64, the thermal head 11, the drivers 45, 46, the light-emitting element 53, the light-receiving element 54 and the input IF 27.

The ROM 62 stores a program for executing main processing shown in FIG. 7. The RAM 63 temporarily stores various information. The storage device 64 includes a non-volatile memory and stores various setting information.

The driver 45 is configured to drive the conveyance motor 47 in accordance with control signals that are input from the CPU 61. The driver 46 is configured to drive the cutting motor 48 in accordance with control signals that are input from the CPU 61. The conveyance motor 47 and the cutting motor 48 are stepping motors.

The CPU 61 is configured to control the thermal head 11 so as to cause the heating elements 19 to produce heat. The CPU 61 is configured to control the light-emitting element 53 so as to cause the light-emitting element 53 to emit light. The light-receiving element 54 is configured to output to the CPU 61 an electric current that corresponds to an amount of received light. The input IF 27 is configured to be operated by a user and output a signal that corresponds to the operation.

The main processing to be executed by the CPU 61 is described below, with reference to FIG. 7. In response to a printing instruction inputted by the user via the input IF 27, the CPU 61 reads out the program for the main processing from the ROM 62. The program includes instructions for causing the CPU 61 to execute the processing described below. The CPU 61 starts the main processing in accordance with the program for the main processing. In the following description, rotation of the platen roller 12 for conveying the medium 6 downstream in the conveyance direction is referred to as a normal rotation. Rotation of the platen roller 12 for conveying the medium 6 upstream in the conveyance direction is referred to as a reverse rotation. A step in the main processing is abbreviated as S.

In response to the start of the main processing, the CPU 61 causes the platen roller 12 to start the reverse rotation by driving the conveyance motor 47 (S1). The processing at S1 causes the platen roller 12 to start conveyance of the medium 6 upstream in the conveyance direction.

The CPU 61 determines whether the edge 801 of one of the marks 8 is detected, based on a detection result of the sensor 50 (S3). In S3, the CPU 61 causes the light-emitting element 53 to emit light toward the medium 6 that is being conveyed by the platen roller 12. The light-receiving element 54 receives reflected light. The release liner 9 of the present embodiment is white, while the marks 8 are black. Therefore, a magnitude of an electric current that is outputted by the light-receiving element 54 in response to receiving light reflected by the release liner 9 is different from a magnitude of an electric current that is outputted by the light-receiving element 54 in response to receiving light reflected by one of the marks 8. The CPU 61 continues the determination based on the magnitude of the electric current outputted from the light-receiving element 54 while conveying the medium 6 upstream in the conveyance direction, until the edge 801 of one of the marks 8 is detected.

Based on a determination that the edge 801 of one of the marks 8 is not detected (NO at S3), the CPU 61 returns the processing to S3. Based on a determination that the edge 801 of one of the marks 8 is detected (YES at S3), the CPU 61 performs positioning of the base material composite 100 that is subject to printing (S5). Specifically, the CPU 61 sets a position of the base material composite 100 based on a position of the corresponding mark 8 detected by the sensor 50. The CPU 61 positions the base material composite 100 while conveying the medium 6 upstream in the conveyance direction such that a downstream edge of the base material composite 100 is held between the thermal head 11 and the platen roller 12.

The CPU 61 causes the platen roller 12 to stop the reverse rotation by stopping driving of the conveyance motor 47 (S7). In response to the processing at S7, the platen roller 12 stops conveying the medium 6 upstream in the conveyance direction.

The CPU 61 causes the platen roller 12 to start the normal rotation by driving the conveyance motor 47 (S9). The processing at S9 causes the platen roller 12 to start conveyance of the medium 6 downstream in the conveyance direction. The CPU 61 performs printing on the base materials 7 of the medium 6 by driving the thermal head 11 (S11). Specifically, the CPU 61 performs thermal printing on the base materials 7 by selectively causing the heating elements 19 to produce heat, while the medium 6 is conveyed. The CPU 61 controls timing to cause the heating elements 19 to produce heat, based on the edge 801 of the mark 8 detected by the sensor 50.

The CPU 61 determines whether the printing on the medium 6 is completed (S13). Based on a determination that the printing is not yet completed (NO at S13), the CPU 61 returns the processing to S13. Based on a determination that the printing is completed (YES at S13), the CPU 61 causes the platen roller 12 to stop the normal rotation by stopping driving of the conveyance motor 47 (S15). The processing at S15 causes the platen roller 12 to stop conveyance of the medium 6 downstream in the conveyance direction.

The CPU 61 causes the cutter 40 to cut the medium 6 by driving the cutting motor 48 (S17). Specifically, the cutter 40 cuts the release liner 9 between two of the base material composites 100 that are adjacent to each other in the conveyance direction. It is noted that the processing of S17 may be omitted. The CPU 61 ends the main processing. The user removes the medium 6 that is discharged through the output slot 22.

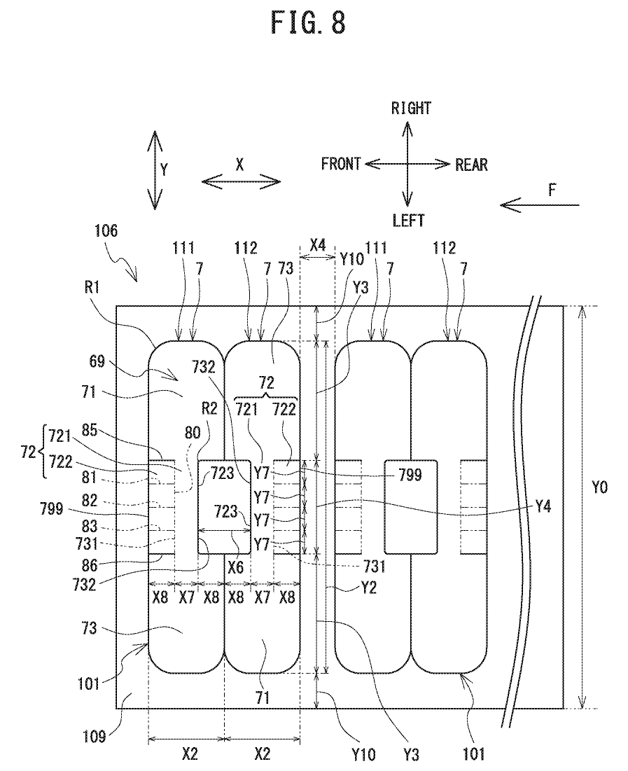

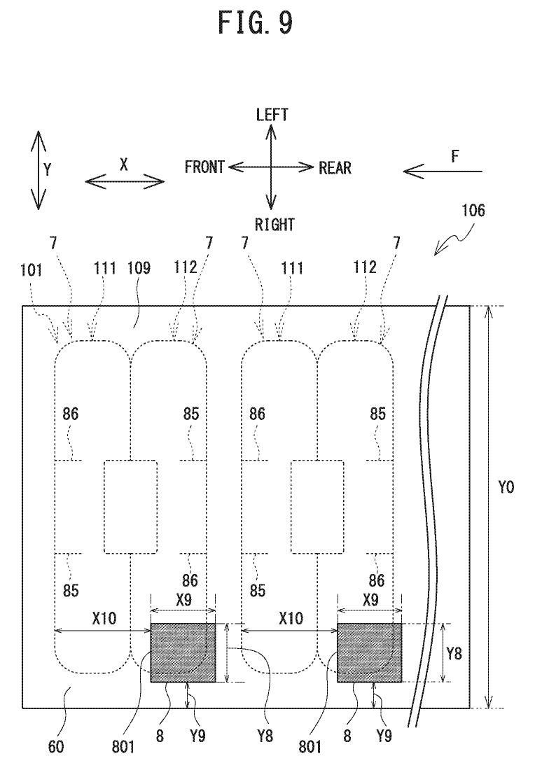

A medium 106 according to a first modified embodiment is described below, with reference to FIGS. 8 and 9. In FIGS. 8 and 9, same reference signs are assigned to elements or structures that are substantially the same as those of the medium 6 of the embodiment shown in FIGS. 2 to 4. The medium 106 of the first modified embodiment differs from the medium 6 of the above-described embodiment in that the medium 106 includes base material composites 101, in place of the base material composites 100, and a release liner 109, in place of the release liner 9. The different elements or structures are mainly described below, while description of the elements or structures that are substantially the same as those of the medium 6 of the above-described embodiment are simplified or omitted.

As shown in FIG. 8, each of the base material composites 101 includes the first base material 111 and the second base material 112, but does not include the blank space 74. Thus, no blank space is affixed to the release liner 109.

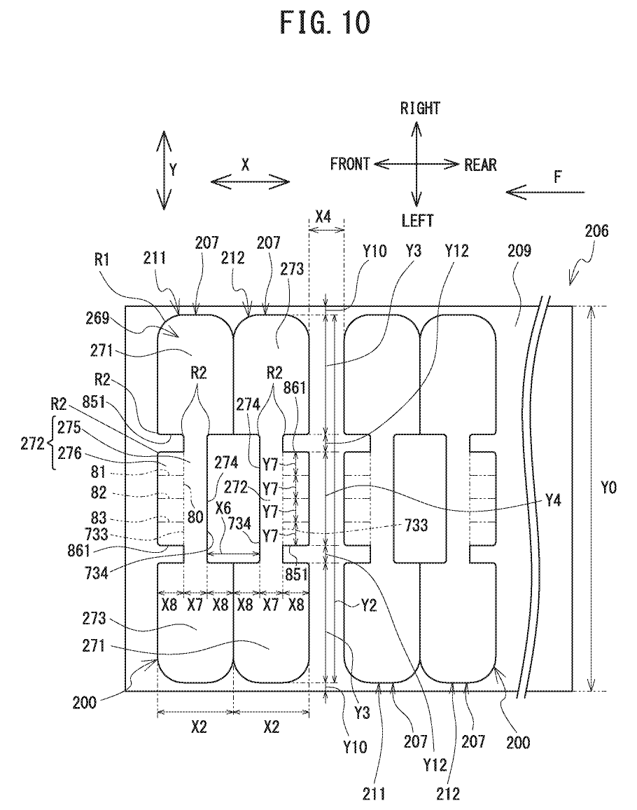

A medium 206 according to a second modified embodiment is described below, with reference to FIG. 10. In FIG. 10, same reference signs are assigned to elements or structures that are substantially the same as those of the medium 6 of the embodiment, and description of these elements or structures are simplified or omitted. The medium 206 of the second modified embodiment includes base material composites 200 and a release liner 209.

Each of the base material composites 200 includes a first base material 211 and a second base material 212, but does not include a blank space that surrounds the first base material 211 and the second base material 212. The first base material 211 and the second base material 212 are affixed to the release liner 209. The first base material 211 and the second base material 212 are in contact with each other in the second direction. When the first base material 211 or the second base material 212 is referred to without specifying which one, the first base material 211 or the second base material 212 is hereinafter simply referred to as a base material 207. The length Y2 of the base material 207 in the first direction is, for example, 63 mm. The length X2 of the base material 207 in the second direction is, for example, 13 mm. The distance X4 in the second direction between two adjacent base material composites 200 is, for example, 6 mm.

Each of the base materials 207 includes a printing surface 269 and the adhesive layer 70 that is substantially the same as that in the above-described embodiment. The release liner 209 of the medium 206 is affixed to the adhesive layers 70 of the base materials 207. Each of the base materials 207 includes a first portion 271, a second portion 272 and a third portion 273.

The first portion 271 has a structure that is substantially the same as the first portion 71 of the above-described embodiment. The first portion 271 has a rectangular shape that is elongated in the first direction. The third portion 273 has a structure that is substantially the same as the third portion 73 of the above-described embodiment. The third portion 273 has a rectangular shape that is elongated in the first direction. The length Y3 of the first portion 271 and of the third portion 273 in the first direction is, for example, 20.5 mm.

The second portion 272 includes a base portion 275 and a fold portion 276. The base portion 275 is aligned or arranged in line with the first portion 271 in the first direction. The base portion 275 is connected to the first portion 271. The base portion 275 has a shorter length than the first portion 271 in the second direction. A basic structure of the fold portion 276 is the same as that of the fold portion 722 in the above-described embodiment.

The medium 206 has a recess 851 between the fold portion 276 and the first portion 271. The recess 851 is recessed from a first one of two opposite edges of the fold portion 276 in the second direction toward a second one of the opposite edges of the fold portion 276. The medium 206 has a recess 861 between the fold portion 276 and the third portion 273. The recess 861 is recessed from the first one of the opposite edges of the fold portion 276 in the second direction toward the second one of the opposite edges of the fold portion 276. The recesses 851, 861 extend in the second direction from one of opposite edges of the second portion 272 in the second direction to a boundary between the base portion 275 and the fold portion 276. The recesses 851, 861 extend through the base material 207 in the thickness direction. The medium 206 thus has a gap between the fold portion 276 and the first portion 271, and another gap between the fold portion 276 and the third portion 273.

A length Y12 of each of the recesses 851, 861 in the first direction, i.e., a width of each of the gaps, is, for example, 3 mm. A length of each of the recesses 851, 861 in the second direction, i.e., a depth of each of the recesses 851, 861, is the same as the length X8, which is the length of each of the cuts 81 to 83. The length X8 is, for example, 4.5 mm.

The fold portion 276 is adjacent to an edge 733, which is a first one of opposite edges 733, 734 of the base portion 275 in the second direction. The base material 207 includes a recess 274 that is adjacent to an edge 734, which is a second one of the opposite edges 733, 734 of the base portion 275 in the second direction. The recess 274 is recessed from an edge of the base material 207 in the second direction toward the edge 733 of the base portion 275, i.e., toward the fold portion 276. The edge 734 of the base portion 275 in the second direction defines an edge of the second portion 272 in the second direction. As in the above-described embodiment, the edge 733 of the base portion 275 of the first base material 211 and the edge 733 of the base portion 275 of the second base material 212 face opposite directions. Specifically, the edge 733 of the base portion 275 of the first base material 211 is a downstream edge of the base portion 275 that faces downstream in the conveyance direction. The edge 733 of the base portion 275 of the second base material 212 is an upstream edge of the base portion 275 that faces upstream of the conveyance direction. A length of the recess 274 in the first direction is equal to a sum of the length Y4 of the fold portion 276 in the first direction and the double of the length Y12 of each of the recesses 851, 861 in the first direction.

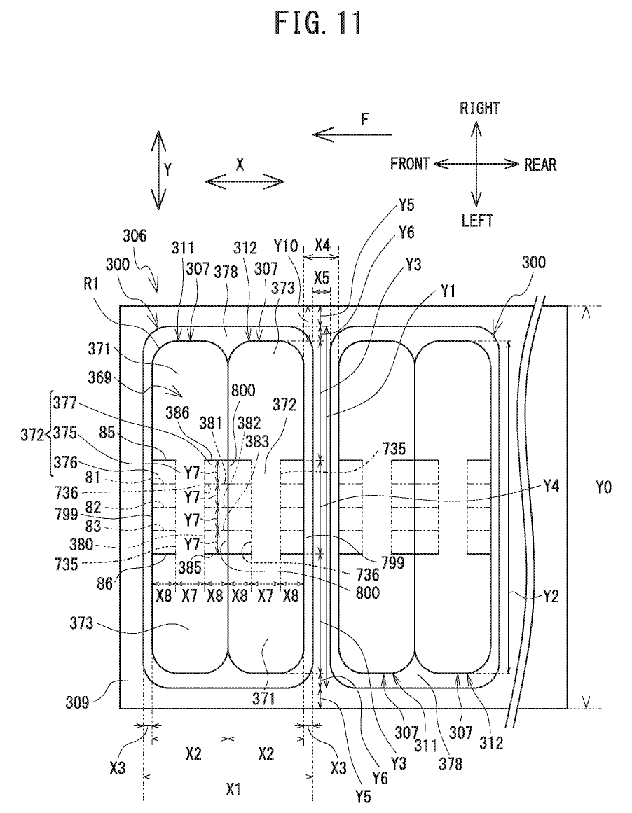

A medium 306 according to a third modified embodiment is described below, with reference to FIG. 11. In FIG. 11, same reference signs are assigned to elements or structures that are substantially the same as those of the medium 6 of the embodiment, and description of these elements or structures are simplified or omitted. The medium 306 of the third modified embodiment includes base material composites 300 and a release liner 309.

Each of the base material composites 300 includes a first base material 311, a second base material 312 and a blank space 378 that is substantially the same as the blank space 74 of the medium 6 in the above-described embodiment. The first base material 311 and the second base material 312 are affixed to the release liner 309. The first base material 311 and the second base material 312 are in contact with each other in the second direction. When the first base material 311 or the second base material 312 is referred to without specifying which one, the first base material 311 or the second base material 312 is hereinafter simply referred to as a base material 307. The length Y2 of the base material 307 in the first direction and the length X2 of the base material 307 in the second direction are the same as those of the base material 7 in the above-described embodiment.

Each of the base materials 307 includes a printing surface 369 and the adhesive layer 70 that is substantially the same as that in the above-described embodiment. The release liner 309 of the medium 306 is affixed to the adhesive layers 70 of the base materials 307. Each of the base material 307 includes a first portion 371, a second portion 372 and a third portion 373.

The first portion 371 has a structure that is substantially the same as the first portion 71 of the above-described embodiment. The first portion 371 has a rectangular shape that is elongated in the first direction. The third portion 373 has a structure that is substantially the same as the third portion 73 of the above-described embodiment. The third portion 373 has a rectangular shape that is elongated in the first direction.

The second portion 372 includes a base portion 375 and fold portions 376, 377. The base portion 375 is aligned or arranged in line with the first portion 371 in the first direction. The base portion 375 is connected to the first portion 371. The base portion 375 has a shorter length than the first portion 371 in the second direction. A length of the second portion 372 in the second direction is equal to the length X2 of the first portion 371 in the first direction.

The fold portion 376 is adjacent to an edge 735, which is a first one of opposite edges 735, 736 of the base portion 375 in the second direction. The fold portion 377 is adjacent to the edge 736, which is a second one of the opposite edges 735, 736 of the base portion 375 in the second direction. The fold portion 376, the base portion 375 and the fold portion 377 are aligned or arranged in line in the second direction, which is perpendicular to the first direction. The fold portion 376 is connected to the edge 735 of the base portion 375 in the second direction. The fold portion 377 is connected to the edge 736 of the base portion 375 in the second direction. The length X8 of each of the fold portions 376, 377 in the second direction may be longer or shorter than the length X7 of the base portion 375 in the second direction. The length X7 is, for example, 5 mm. The length X8 is, for example, 4 mm.

A basic structure of the fold portion 376 is the same as that of the fold portion 722 in the above-described embodiment. The second portion 372 includes cuts 381 to 383, i.e., 381, 382 and 383. Specifically, the fold portion 377 includes the cuts 381 to 383 that extend through the base material 307 in the thickness direction. The cuts 381 to 383 are equally spaced, by the distance Y7, in the first direction.

The base material 307 includes a cut 385 between the fold portion 377 and the first portion 371. The base material 307 also includes a cut 386 between the fold portion 377 and the third portion 373. The cuts 385, 386 linearly extend in the second direction from a center of the base material composite 300 in the second direction to a boundary between the base portion 375 and the fold portion 377. In other words, the cuts 385, 386 extend from the edge 800, which is a second one of opposite edges 799, 800 of the second portion 372 in the second direction, to the boundary between the base portion 375 and the fold portion 377. The cuts 385, 386 extend through the base material 307 in the thickness direction.

The medium 306 has a cut 380 that extends along or on a boundary between the base portion 375 and the fold portion 377. The cut 380 is a perforated line that includes a plurality of cuts extending through the base material 307 in the thickness direction. The cut 380 is disposed in the second portion 372 in order to facilitate folding the base material 307 along the boundary between the fold portion 377 and the base portion 375.

Each of the base materials 307 is symmetric with respect to a center of the base material 307 in a longitudinal direction of the base material 307, i.e., in the first direction. The third portion 373 and the first portion 371 are thus line-symmetric to each other with respect to the center of the base material 307 in the first direction. Each of the base materials 307 is also symmetric with respect to a center of the base material 307 in a width direction of the base material 307, i.e., in the second direction. The fold portion 376 and the fold portion 377 are thus line-symmetric to each other with respect to the center of the base material 307 in the second direction.

In order to attach a printed base material 307 to the object T, a user of the medium 306 peels the printed base material 307 from the release liner 309. The user folds the fold portion 376 along the cut 80 such that the adhesive layer 70 of the fold portion 376 is affixed to the adhesive layer 70 of the base portion 375. The user folds the fold portion 377 along the cut 380 such that the adhesive layer 70 of the fold portion 377 is affixed to the printing surface 369 of the fold portion 376. Other operations in the process of attaching the base material 307 to the object T are substantially the same as those explained in the above-described embodiment, and thus are not explained here.

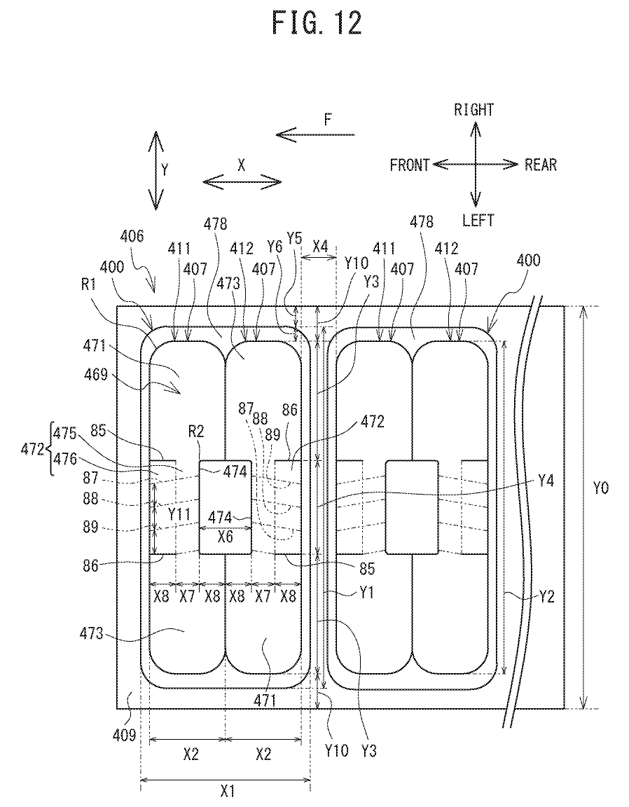

A medium 406 according to a fourth modified embodiment is described below, with reference to FIG. 12. In FIG. 12, same reference signs are assigned to elements or structures that are substantially the same as those of the medium 6 of the embodiment, and description of these elements or structures are simplified or omitted. The medium 406 of the fourth modified embodiment includes base material composites 400 and a release liner 409.

Each of the base material composites 400 includes a first base material 411, a second base material 412 and a blank space 478 that is substantially the same as the blank space 74 of the medium 6 in the above-described embodiment. The first base material 411 and the second base material 412 are affixed to the release liner 409. The first base material 411 and the second base material 412 are in contact with each other in the second direction. When the first base material 411 or the second base material 412 is referred to without specifying which one, the first base material 411 or the second base material 412 is hereinafter simply referred to as a base material 407. The length Y2 of the base material 407 in the first direction and the length X2 of the base material 407 in the second direction are the same as those of the base material 7 in the above-described embodiment.

Each of the base materials 407 includes a printing surface 469 and the adhesive layer 70 that is substantially the same as that in the above-described embodiment. The release liner 409 of the medium 406 is affixed to the adhesive layers 70 of the base materials 407. Each of the base materials 407 includes a first portion 471, a second portion 472, a third portion 473 and a recess 474.

The first portion 471 has a structure that is substantially the same as the first portion 71 of the above-described embodiment. The first portion 471 has a rectangular shape that is elongated in the first direction. The third portion 473 has a structure that is substantially the same as the third portion 73 of the above-described embodiment. The third portion 473 has a rectangular shape that is elongated in the first direction. The recess 474 has a structure that is substantially the same as the recess 723 of the above-described embodiment.

The second portion 472 includes a base portion 475 and a fold portion 476. The base portion 475 is different from the base portion 721 of the above-described embodiment in that the base portion 475 includes cuts 87 to 89, i.e., 87, 88 and 89. Other elements or structures of the base portion 475 are substantially the same as those of the base portion 721 of the above-described embodiment. The fold portion 476 is different from the fold portion 722 of the above-described embodiment in that the fold portion 476 includes the cuts 87 to 89, in place of the cuts 81 to 83. Other elements or structures of the fold portion 476 are substantially the same as those of the fold portion 722 of the above-described embodiment. Each of the cuts 87 to 89 extends continuously over the base portion 475 and the fold portion 476.

The second portion 472 of the fourth modified embodiment includes the cuts 87 to 89 each extending through the base material 407 in the thickness direction and extending over the base portion 475 and the fold portion 476. A longitudinal direction of each of the cuts 87 to 89 crosses the first direction and the second direction. The cuts 87 to 89 are equally spaced, by a distance Y11, in the first direction. Inclination of each of the cuts 87 to 89 may be changed as appropriate.

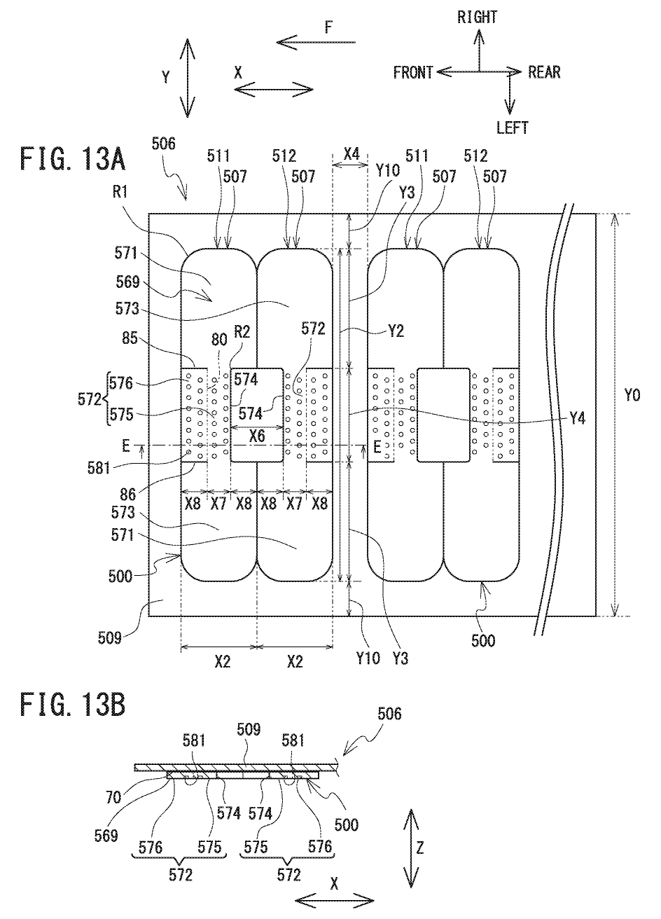

A medium 506 according to a fifth modified embodiment is described below, with reference to FIGS. 13A and 13B. In FIGS. 13A and 13B, same reference signs are assigned to elements or structures that are substantially the same as those of the medium 6 of the embodiment, and description of these elements or structures are simplified or omitted. The medium 506 of the fifth modified embodiment includes base material composites 500 and a release liner 509.

Each of the base material composites 500 includes a first base material 511 and a second base material 512. The first base material 511 and the second base material 512 are affixed to the release liner 509. The first base material 511 and the second base material 512 are in contact with each other in the second direction. When the first base material 511 or the second base material 512 is referred to without specifying which one, the first base material 511 or the second base material 512 is hereinafter simply referred to as a base material 507. The length Y2 of the base material 507 in the first direction and the length X2 of the base material 507 in the second direction are the same as those of the base material 7 in the above-described embodiment.

Each of the base materials 507 includes a printing surface 569 and the adhesive layer 70 that is substantially the same as that in the above-described embodiment. The release liner 509 of the medium 506 is affixed to the adhesive layers 70 of the base materials 507. Each of the base materials 507 includes a first portion 571, a second portion 572, a third portion 573 and a recess 574.

The first portion 571 has a structure that is substantially the same as the first portion 71 of the above-described embodiment. The first portion 571 has a rectangular shape that is elongated in the first direction. The third portion 573 has a structure that is substantially the same as the third portion 73 of the above-described embodiment. The third portion 573 has a rectangular shape that is elongated in the first direction. The recess 574 has a structure that is substantially the same as the recess 723 of the above-described embodiment.

The second portion 572 includes a base portion 575 and a fold portion 576. The base portion 575 is different from the base portion 721 of the above-described embodiment in that the base portion 575 includes a plurality of recesses 581. Other elements or structures of the base portion 575 are substantially the same as those of the base portion 721 of the above-described embodiment. The fold portion 576 is different from the fold portion 722 of the above-described embodiment in that the fold portion 576 includes the recesses 581, in place of the cuts 81 to 83. Other elements or structures of the fold portion 576 are substantially the same as those of the fold portion 722 of the above-described embodiment.

Each of the recesses 581 extends or is recessed in the thickness direction, but does not extend through the base material 507. In other words, a depth of each of the recesses 581 is smaller than the thickness of the base material 507. Each of the recesses 581 is a small circle having a diameter of about 1 mm in a bottom view. The recesses 581 are formed by debossing, for example. The recesses 581 are disposed in an entirety of the base portion 575 and an entirety of the fold portion 576 such that a density of the recesses 581 in the base portion 575 is substantially the same as a density of the recesses 581 in the fold portion 576.

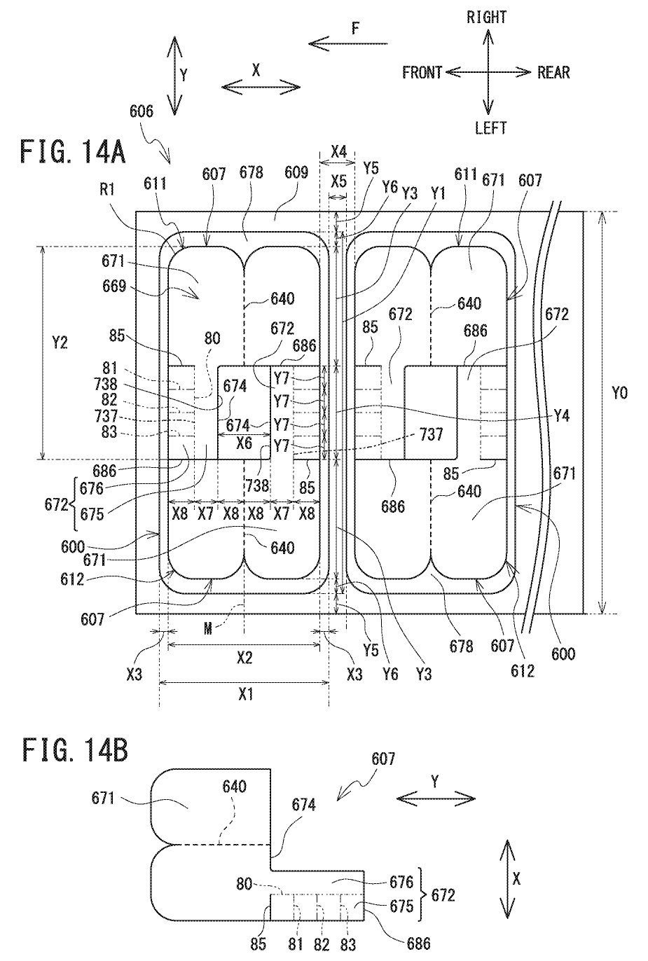

A medium 606 according to a sixth modified embodiment is described below, with reference to FIGS. 14A and 14B. In FIGS. 14A and 14B, same reference signs are assigned to elements or structures that are substantially the same as those of the medium 6 of the embodiment, and description of these elements or structures are simplified or omitted. The medium 606 of the sixth modified embodiment includes base material composites 600 and a release liner 609.

As shown in FIG. 14A, each of the base material composites 600 includes a first base material 611, a second base material 612 and a blank space 678 that is substantially the same as the blank space 74 of the medium 6 in the above-described embodiment. The first base material 611 and the second base material 612 are affixed to the release liner 609. The first base material 611 and the second base material 612 are in contact with each other in the first direction. When the first base material 611 or the second base material 612 is referred to without specifying which one, the first base material 611 or the second base material 612 is hereinafter simply referred to as a base material 607. The length Y2 of the base material 607 in the first direction is shorter than the length Y1 of the base material composite 600 in the first direction. The length Y2 is, for example, 36.5 mm. The length X2 of the base material 607 in the second direction is, for example, 26 mm. The distance X5 between two material composites 600 that are adjacent to or next to each other in the second direction is, for example, 3 mm.

Each of the base materials 607 includes a printing surface 669 and the adhesive layer 70 that is substantially the same as that in the above-described embodiment. The release liner 609 of the medium 606 is affixed to the adhesive layers 70 of the base materials 607. Each of the base materials 607 is L-shaped. Each of the base materials 607 includes a first portion 671, a second portion 672 and a recess 674.

The first portion 671 has a rectangle shape that is elongated in the second direction. The first portion 671 of the base material 607 has a fold line 640 that passes a center M of the first portion 671 in the second direction and extends in the first direction. The fold line 640 is provided for facilitating folding of the first portion 671 along the fold line 640 so that the adhesive layers 70 of folded portions of the first portion 671 are affixed to each other. The fold line 640 is, for example, a perforated line that includes a plurality of cuts extending through the first portion 671 in the thickness direction.

The second portion 672 includes a base portion 675 and a fold portion 676. The base portion 675 is aligned or arranged in line with the first portion 671 in the first direction. The base portion 675 is connected to the first portion 671 in the first direction. The base portion 675 has a shorter length than the first portion 671 in the second direction. In the second direction, A location where the base portion 675 is connected to the first portion 671 is between the fold portion 676 and the center M of the first portion 671 in the second direction.

The fold portion 676 is adjacent to an edge 737, which is a first one of opposite edges 737, 738 of the base portion 675 in the second direction. The fold portion 676 and the base portion 675 are aligned or arranged in line in the second direction. The fold portion 676 is connected to the edge 737 of the base portion 675 in the second direction. The edge 738, which is a second one of the opposite edges 737, 738 of the base portion 675 in the second direction, defines an edge of the second portion 672 in the second direction. The length X8 of the fold portion 676 in the second direction is longer than the length X7 of the base portion 675 in the second direction. The length X7 is, for example, 4 mm. The length X8 is, for example, 4.5 mm.

An edge 686, which is one of opposite edges of the second portion 672 of the first base material 611 that are opposite from each other in the first direction, is in contact with an edge of the first portion 671 of the second base material 612. The edge 686, which is one of opposite edges of the second portion 672 of the second base material 612 in the first direction, is in contact with an edge of the first portion 671 of the first base material 611. The first base material 611 and the second base material 612 are point-symmetric about a center of the base material composite 600.

In order to attach a printed base material 607 to the object T, a user of the medium 606 peels the printed base material 607 from the release liner 609. The user folds the fold portion 676 along the cut 80 such that the adhesive layer 70 of the fold portion 676 is affixed to the adhesive layer 70 of the base portion 675. The user passes the second portion 672 through the hole of the object T. The user folds the first portion 671 along the fold line 640 such that an end portion of the second portion 672 is sandwiched between the adhesive layers 70 of the folded portions of the first portion 671 to be bonded together. The printed base material 607 is attached to the object T in a manner described above.

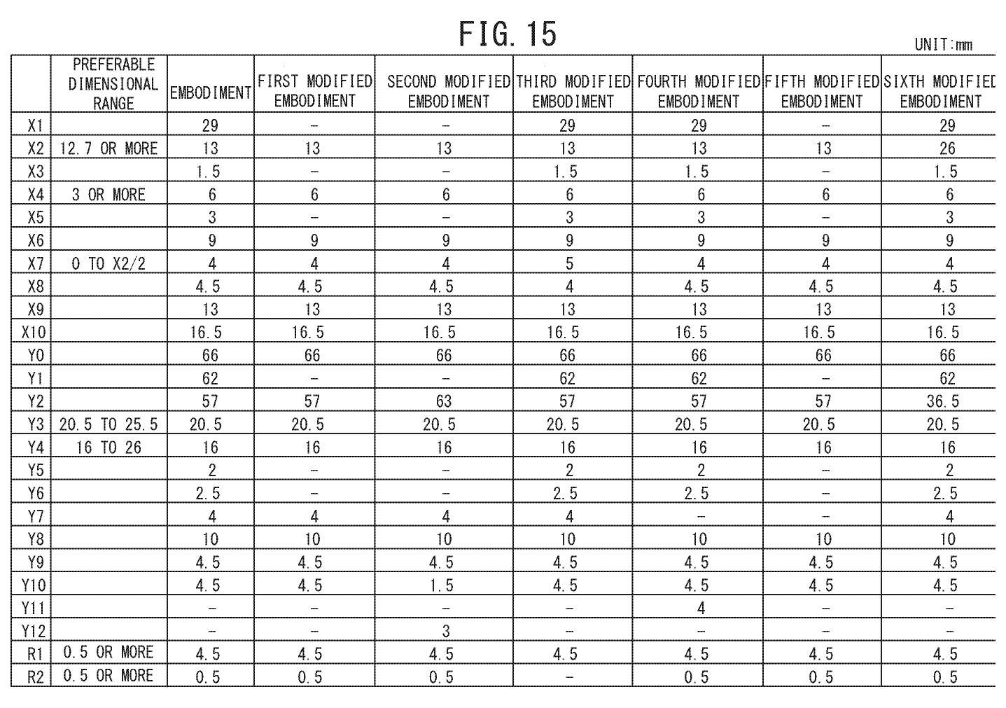

FIG. 15 shows examples of various dimensions of the medium 6 of the embodiment, the medium 106 of the first modified embodiment, the medium 206 of the second modified embodiment, the medium 306 of the third modified embodiment, the medium 406 of the fourth modified embodiment, the medium 506 of the fifth modified embodiment and the medium 606 of the sixth modified embodiment. It is noted, however, the dimensions of the mediums 6, 106, 206, 306, 406, 506 and 606 are not limited to those examples shown in FIG. 15. Under a condition that the length Y0 is 66 mm, each dimension may be preferably set to a value that falls within a corresponding preferable range shown in FIG. 15.

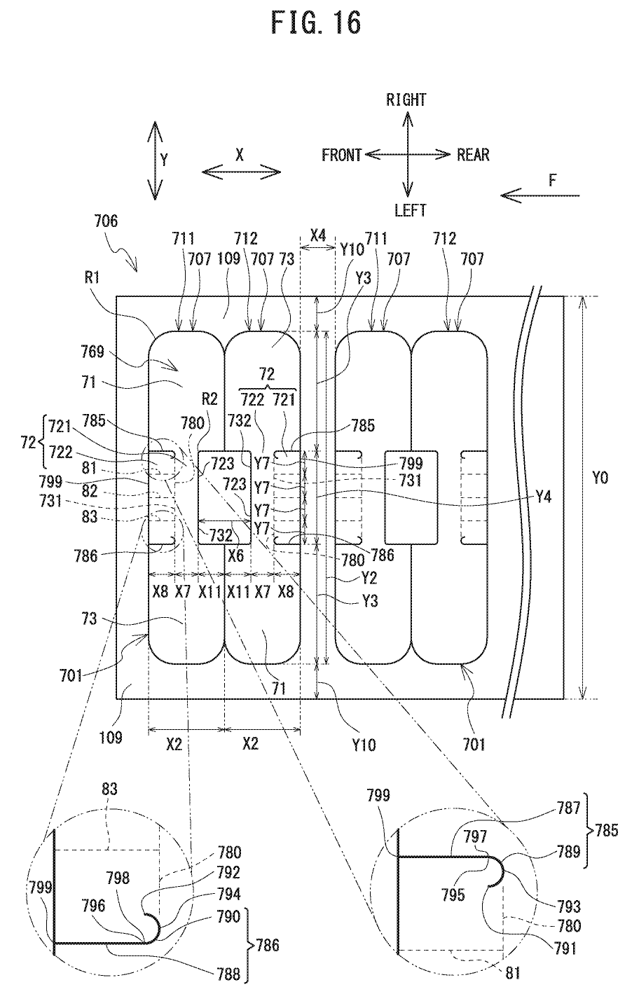

The cut 85 of the medium 6 of the above-described embodiment that separates the first portion 71 and the fold portion 722 of the second portion 72 in the first direction may have a different shape. The cut 86 of the medium 6 that separates the third portion 73 and the fold portion 722 of the second portion 72 may have a different shape. Various modified embodiments of mediums with cuts having different shapes from the cuts 85, 86 are described below, with reference to FIGS. 16 to 22.

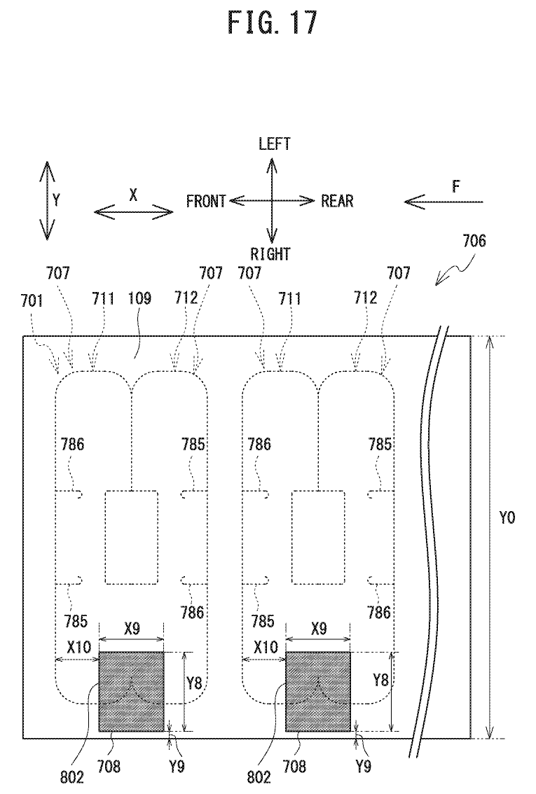

A medium 706 according to a seventh modified embodiment is described below, with reference to FIGS. 16 and 17. In FIGS. 16 and 17, same reference signs are assigned to elements or structures that are substantially the same as those of the medium 6 of the embodiment or the medium 106 of the first modified embodiment, and description of these elements or structures are simplified or omitted.

As shown in FIG. 16, the medium 706 of the seventh modified embodiment includes base material composites 701 and a release liner 109. Each of the base material composites 701 includes a first base material 711 and a second base material 712, but does not include a blank space that surrounds the first base material 711 and the second base material 712. The first base material 711 and the second base material 712 are affixed to the release liner 109. The first base material 711 and the second base material 712 are in contact with each other in the second direction. When the first base material 711 or the second base material 712 is referred to without specifying which one, the first base material 711 or the second base material 712 is hereinafter simply referred to as a base material 707. The length Y2 of the base material 707 in the first direction is, for example, 57 mm. The length X2 of the base material 707 in the second direction is, for example, 13 mm. The distance X4 in the second direction between two adjacent base material composites 701 is, for example, 5 mm.

Each of the base materials 707 includes a printing surface 769 and the adhesive layer 70 that is substantially the same as that in the above-described embodiment. The release liner 109 of the medium 706 is affixed to the adhesive layers 70 of the base materials 707. Each of the base materials 707 includes the first portion 71, the second portion 72 and the third portion 73.

The second portion 72 includes the base portion 721 and the fold portion 722. The fold portion 722 is adjacent to the edge 731, which is the first one of the opposite edges 731, 732 of the base portion 721 in the second direction. The length X2 of the first portion 71 in the second direction is 13 mm. The length X8 of the fold portion 722 of the second portion 72 in the second direction is 4 mm. The length X7 of the base portion 721 is 4 mm. A length or depth X11 of the recess 723 in the second direction is, for example, 5 mm.

The second portion 72 includes the cuts 81 to 83 that extend in the thickness direction of the base material 707. The medium 706 includes a cut 780 along or on the boundary between the base portion 721 and the fold portion 722. The cut 780 is a perforated line that includes a plurality of cuts extending through the base material 707 in the thickness direction. The cut 780 is disposed in the second portion 72 in order to facilitate folding the base material 707 along the boundary between the fold portion 722 and the base portion 721.

The base material 707 includes a separation line 785 that separates the fold portion 722 and the first portion 71 in the first direction. The base material 707 also includes a separation line 786 that separates the fold portion 722 and the third portion 73 in the first direction. The separation lines 785, 786 extend through the base material 707 in the thickness direction. The separation lines 785, 786 extend from an edge 799, which is a first one of the opposite edges 732, 799 of the second portion 72 that are opposite from each other in the second direction, to the boundary between the base portion 721 and the fold portion 722. Each of the separation lines 785, 786 is shaped like a hook that is open toward the edge 799 of the second portion 72 in the second direction. As in the above-described embodiment, the edge 799 of the second portion 72 of the first base material 711 and the edge 799 of the second portion 72 of the second base material 712 face opposite directions. Therefore, the hook in the first base material 711 is open frontward. The hook of the second base material 712 is open rearward. Each of the separation lines 785, 786 is spaced apart from the cut 780 in the first direction. The cut 780 is located between the separation line 785 and the separation line 786 in the first direction.

The separation line 785 includes a linear portion 787 and a curved portion 789. The linear portion 787 linearly extends from the edge 799 of the second portion 72 toward an edge 732, which is a second one of the opposite edges 732, 799 of the second portion 72 in the second direction. The linear portion 787 has a distal end 795 that is spaced apart from the edge 799 of the second portion 72. The curved portion 789 has opposite ends, a first end 797 and a second end 791, of which the first end 797 is connected to the distal end 795 of the linear portion 787. The curved portion 789 extends from the distal end 795 of the linear portion 787 in a clockwise direction in the bottom view while curving in an arc. The curved portion 789 thus curves away from the first portion 71. The curved portion 789 may be shaped like a circular arc or an elliptic arc. The curved portion 789 of the seventh modified embodiment curves in an arc between the distal end 795 of the linear portion 787 and the boundary between the base portion 721 and the fold portion 722 in the second direction. A radius of curvature of the curved portion 789 is preferably within a range from 0.3 mm to 5 mm, inclusive, and more preferably, within a range from 0.5 mm to 1 mm, inclusive.

The second end 791 of the curved portion 789 is located between the edge 799 of the second portion 72 and a point 793 on the curved portion 789 that is located farthest from the edge 799 of the second portion 72 in the second direction. A virtual central angle of the curved portion 789, which is an arc, is greater than 90 degrees. The second end 791 of the curved portion 789 is located in the fold portion 722 of the second portion 72. The point 793 on the curved portion 789 may be at a same location in the second direction as the boundary between the base portion 721 and the fold portion 722. Alternatively, the point 793 on the curved portion 789 may be located between the edge 799 of the second portion 72 and the boundary between the base portion 721 and the fold portion 722 in the second direction. A distance in the second direction between the point 793 on the curved portion 789 and the boundary between the base portion 721 and the fold portion 722 is preferably 1 mm or less. In the seventh modified embodiment, the distance in the second direction between the point 793 on the curved portion 789 and the boundary between the base portion 721 and the fold portion 722 is 0 mm. In other words, the point 793 on the curved portion 789 is at the same location in the second direction as the boundary between the base portion 721 and the fold portion 722.

The separation line 786 includes a linear portion 788 and a curved portion 790. The linear portion 788 linearly extends from the edge 799 of the second portion 72. The linear portion 788 has a distal end 796 that is spaced apart from the edge 799 of the second portion 72. The curved portion 790 has opposite ends, a first end 798 and a second end 792, of which the first end 798 is connected to the distal end 796 of the linear portion 788. The curved portion 790 extends from the distal end 796 of the linear portion 788 in a counterclockwise direction in the bottom view while curving in an arc. The curved portion 790 thus curves away from the third portion 73. The curved portion 790 may be shaped like a circular arc or an elliptic arc. The curved portion 790 of the seventh modified embodiment curves in an arc between the distal end 796 of the linear portion 788 and the boundary between the base portion 721 and the fold portion 722 in the second direction. A radius of curvature of the curved portion 790 is preferably within a range from 0.3 mm to 5 mm, inclusive, and more preferably, within a range from 0.5 mm to 1 mm, inclusive. The radius of curvature of each of the curved portions 789, 790 is, for example, 0.5 mm.

The second end 792 of the curved portion 790 is located between the edge 799 of the second portion 72 and a point 794 on the curved portion 790 that is located farthest from the edge 799 of the second portion 72 in the second direction. A virtual central angle of the curved portion 790, which is an arc, is greater than 90 degrees. The second end 792 of the curved portion 790 is located in the fold portion 722 of the second portion 72. The point 794 on the curved portion 790 may be at a same location in the second direction as the boundary between the base portion 721 and the fold portion 722. Alternatively, the point 794 on the curved portion 790 may be located between the edge 799 of the second portion 72 and the boundary between the base portion 721 and the fold portion 722 in the second direction. A distance in the second direction between the point 794 on the curved portion 790 and the boundary between the base portion 721 and the fold portion 722 is preferably 1 mm or less.

As shown in FIG. 17, the release liner 109 has a plurality of marks 708 on a surface that is opposite from a surface on which the base material composites 701 are affixed. The marks 708 are equally spaced and aligned in the conveyance direction of the medium 706. In the present embodiment, each of the marks 708 is a black rectangle. The length Y8 of the mark 708 in the first direction is, for example, 16 mm. The distance Y9 in the first direction between the mark 708 and an edge of the release liner 109 in the first direction is, for example, 1.6 mm. The length X9 of the mark 708 in the second direction is, for example, 13 mm. The distance X10 in the conveyance direction between a downstream edge 802 of the mark 708 and a downstream edge of the first base material 711 that is disposed downstream of the mark 708 is, for example, 8 mm.

Each of the marks 708 corresponds to one of the base material composites 701. An upstream edge of the mark 708 is located downstream of an upstream edge of the corresponding base material composite 701 in the conveyance direction. An edge of the base material composite 701 in the first direction is located between opposite edges of the mark 708 in the first direction. The mark 708 is offset from or does not overlap a center of the medium 706 in the first direction. While the medium 706 is conveyed by the platen roller 12 in the conveyance direction, the mark 708 passes a location directly below the sensor 50. A size of the mark 708 is sufficiently large, relative to the area A that is exposed to the light from the sensor 50. The mark 708 is utilized in a process of determining a position of the corresponding base material composite 701.

An unexpectedly strong force may be applied between the first portion 71 and the second portion 72, depending on various conditions such as adhesion power of the adhesive layer 70, a direction in which the base material 707 is peeled from the release liner 109, and a speed at which the base material 707 is peeled from the release liner 109. Under the condition that an unexpectedly strong force is applied between the first portion 71 and the second portion 72, the medium 706 contributes to reducing a possibility that the base material 707 is torn between the first portion 71 and the base portion 721 of the second portion 72, and between the third portion 73 and the base portion 721 of the second portion 72, as compared to the medium 106 of the first modified embodiment with the cuts 85, 86 that linearly extend in the second direction.

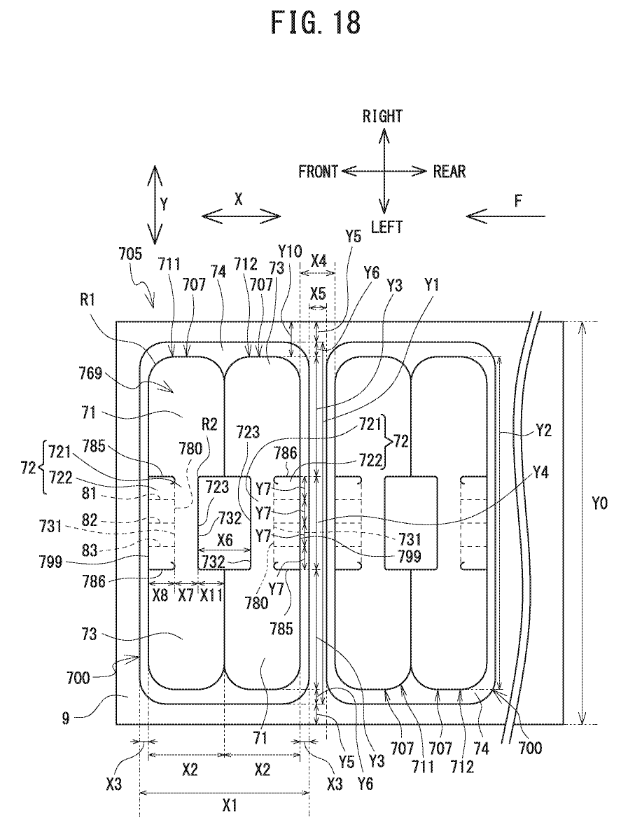

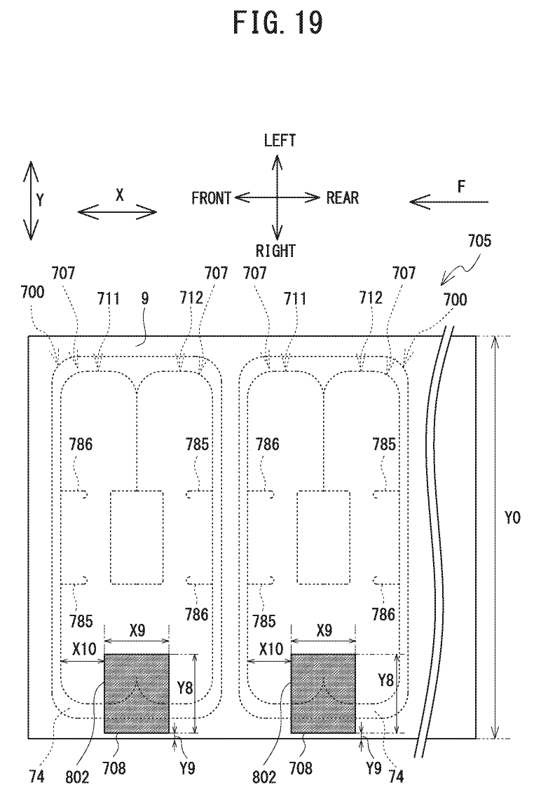

A medium 705 according to an eighth modified embodiment is described below, with reference to FIGS. 18 and 19. In FIGS. 18 and 19, same reference signs are assigned to elements or structures that are substantially the same as those of the medium 6 of the embodiment or the medium 706 of the seventh modified embodiment, and description of these elements or structures are simplified or omitted. The medium 705 of the eighth modified embodiment differs from the medium 706 of the seventh modified embodiment in that the medium 705 includes base material composites 700, in place of the base material composites 701, and a release liner 9, in place of the release liner 109. As shown in FIGS. 18 and 19, each of the base material composites 700 includes a first base material 711 and a second base material 712, and the blank space 74.

The dimensions of the first portion 71, the second portion 72 and the third portion 73 of the medium 706 of the seventh modified embodiment and the medium 705 of the eighth modified embodiment may be changed as appropriate. For example, the length X2 of the second portion 72 in the second direction may be 13 mm. The length X8 of the fold portion 722 of the second portion 72 in the second direction may be 4.5 mm. The length X7 of the base portion 721 in the second direction may be 4 mm. Thus, the length X8 of the fold portion 722 in the second direction may be longer than the length X7 of the base portion 721 in the second direction.

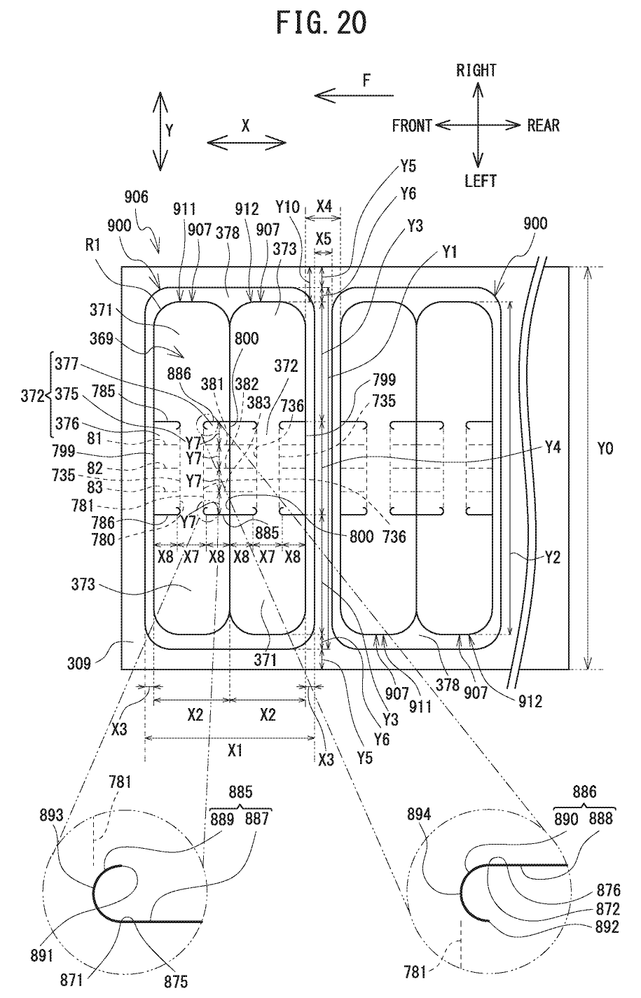

A medium 906 according to a ninth modified embodiment is described below, with reference to FIG. 20. In FIG. 20, same reference signs are assigned to elements or structures that are substantially the same as those of the medium 6 of the embodiment, the medium 306 of the third modified embodiment or the medium 706 of the seventh modified embodiment, and description of these elements or structures are simplified or omitted. The medium 906 of the ninth modified embodiment includes base material composites 900 and the release liner 309.

Each of the base material composites 900 includes a first base material 911, a second base material 912 and the blank space 378. The first base material 911 and the second base material 912 are affixed to the release liner 309. The first base material 911 and the second base material 912 are in contact with each other in the second direction. When the first base material 911 or the second base material 912 is referred to without specifying which one, the first base material 911 or the second base material 912 is hereinafter simply referred to as a base material 907. The length Y2 of the base material 907 in the first direction and the length of X2 of the base material 907 in the second direction are the same as those of the base material 7 of the above-described embodiment.

Each of the base materials 907 includes a printing surface 369 and the adhesive layer 70 that is substantially the same as that in the above-described embodiment. The release liner 309 of the medium 906 is affixed to the adhesive layers 70 of the base materials 907. Each of the base materials 907 includes the first portion 371, the second portion 372 and the third portion 373. The second portion 372 includes the base portion 375 and the fold portions 376, 377.

The base material 907 includes the separation line 785 between the fold portion 376 and the first portion 371. The base material 907 also includes the separation line 786 between the fold portion 376 and the third portion 373. The separation lines 785, 786 extend from the edge 799, which is a first one of the opposite edges 799, 800 of the second portion 372 in the second direction, to the boundary between the base portion 375 and the fold portion 376. In addition, the base material 907 includes a separation line 886 between the fold portion 377 and the first portion 371. The base material 907 also includes a separation line 885 between the fold portion 377 and the third portion 373. The separation lines 885, 886 linearly extend in the second direction from a center of the base material composite 900 in the second direction to the boundary between the base portion 375 and the fold portion 377. In other words, the separation lines 885, 886 extend from the edge 800, which is the second one of the opposite edges 799, 800 of the second portion 372 in the second direction, to the boundary between the base portion 375 and the fold portion 377. The separation lines 785, 786, 885, 886 extend through the base material 907 in the thickness direction.

The separation line 885 includes a linear portion 887 and a curved portion 889. The linear portion 887 linearly extends from the edge 800 of the second portion 372 toward the edge 799 of the second portion 372 in the second direction. A first end 875 of the curved portion 889 is connected to a distal end 871, which is spaced apart from the edge 800, of the linear portion 887. The curved portion 889 extends from the distal end 871 of the linear portion 887 in the clockwise direction in the bottom view while curving in an arc.

A second end 891 of the curved portion 889 is located between the edge 800 and a point 893 on the curved portion 889 that is located farthest from the edge 800. A virtual central angle of the curved portion 889, which is an arc, is greater than 90 degrees. The second end 891 of the curved portion 889 is located in the fold portion 377 of the second portion 372. A radius of curvature of the curved portion 889 is within a range from 0.3 mm to 5 mm, inclusive.

The separation line 886 includes a linear portion 888 and a curved portion 890. The linear portion 888 linearly extends from the edge 800 toward the edge 799 in the second direction. A first end of the curved portion 890 is connected to a distal end 872, which is spaced apart from the edge 800, of the linear portion 888. The curved portion 890 extends from the distal end 872 of the linear portion 888 in the counterclockwise direction in the bottom view while curving in an arc.

A second end 892 of the curved portion 890 is located between the edge 800 of the second portion 372 in the second direction, and a point 894 on the curved portion 890 that is located farthest from the edge 800. A virtual central angle of the curved portion 890, which is an arc, is greater than 90 degrees. The second end 892 of the curved portion 890 is located in the fold portion 377 of the second portion 372. A radius of curvature of the curved portion 890 is within a range from 0.3 mm to 5 mm, inclusive. The radius of curvature of each of the curved portions 889, 890 is, for example, 0.5 mm.

The medium 906 includes a cut 781 along or on the boundary between the base portion 375 and the fold portion 377. The cut 781 is a perforated line that includes a plurality of cuts extending through the base material 907 in the thickness direction. The cut 781 is disposed in the second portion 372 in order to facilitate folding the base material 907 along the boundary between the fold portion 377 and the base portion 375. The cut 781 is located between the separation line 885 and the separation line 886 in the first direction. Each of the separation lines 885, 886 is spaced apart from the cut 781 in the first direction.

Each of the base materials 907 is symmetric with respect to a center of the base material 907 in a longitudinal direction of the base material 307, i.e., in the first direction. The third portion 373 and the first portion 371 are thus line-symmetric to each other with respect to the center of the base material 907 in the first direction. Each of the base materials 907 is also symmetric with respect to a center of the base material 907 in a width direction of the base material 907, i.e., in the second direction. The fold portion 376 and the fold portion 377 are thus line-symmetric to each other with respect to the center of the base material 907 in the second direction.

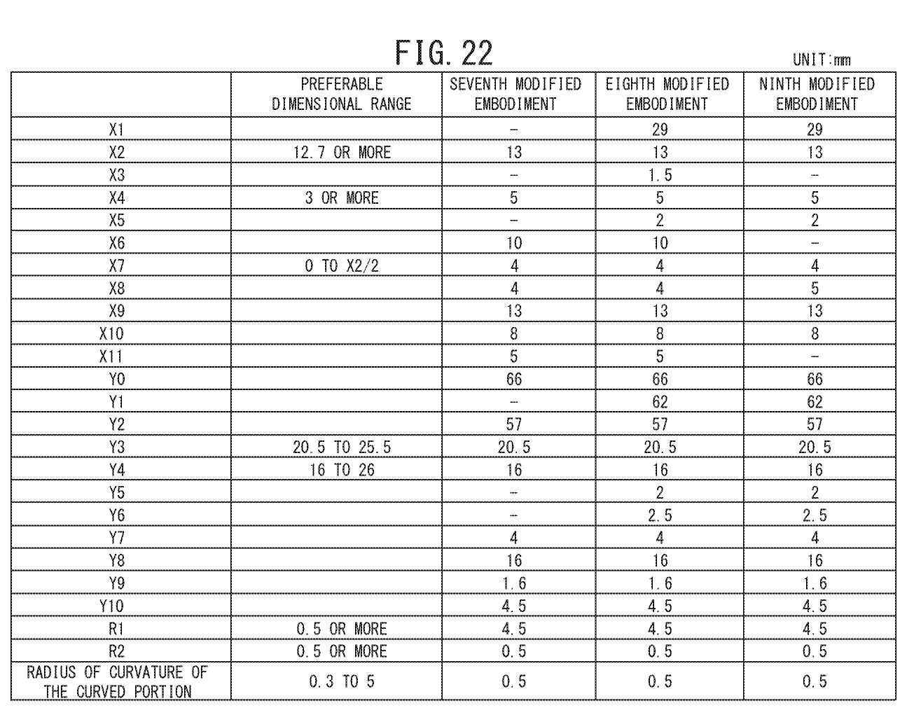

FIG. 22 shows examples of dimensions of the medium 706 of the seventh modified embodiment, the medium 705 of the eighth modified embodiment and the medium 906 of the ninth modified embodiment. It is noted, however, the dimensions of the mediums 706, 705 and 906 are not limited to those examples shown in FIG. 22. Under a condition that the length Y0 is 66 mm, each dimension may be preferably set to a value that falls within a corresponding preferable range shown in FIG. 22.

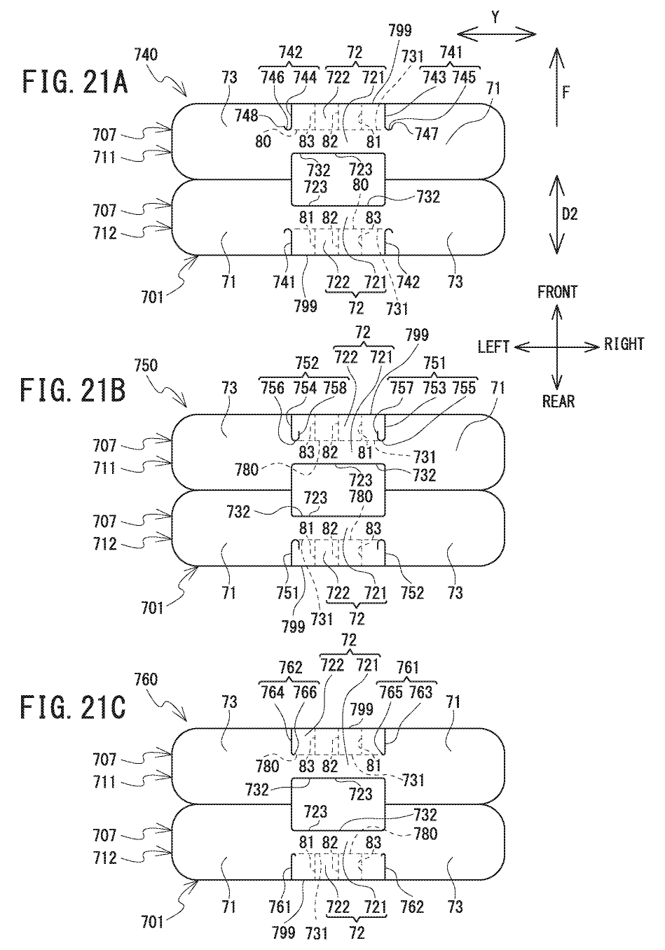

In the seventh to ninth modified embodiments, shapes of the separation lines 785, 786, 885, and 886 may be modified as appropriate. FIGS. 21 A to 21C, i.e., 21A, 21B and 21C, show various examples of such modifications of the separation lines 785, 786. In FIGS. 21A to 21C, same reference signs are assigned to elements or structures that are substantially the same as those of the base material 707 of the seventh modified embodiment, and description of these elements or structures are simplified or omitted.

A base material composite 740 shown in FIG. 21A includes a separation line 741 in place of the separation line 785. The base material composite 740 also includes a separation line 742 in place of the separation line 786.

The separation line 741 includes a linear portion 743 and a curved portion 745. The linear portion 743 linearly extends from the edge 799, which is the first one of the opposite edges 732, 799 of the second portion 72 in the second direction, toward the edge 732, which is the second one of the opposite edges 732, 799 of the second portion 72 in the second direction. A first end of the curved portion 745 is connected to a distal end, which is spaced apart from the first one of the edges of the second portion 72, of the linear portion 743. The curved portion 745 extends from the distal end of the linear portion 743 in the counterclockwise direction in the bottom view while curving in an arc. A second end 747 of the curved portion 745 is located in the first portion 71. A radius of curvature of the curved portion 745 is within a range from 0.3 mm to 5 mm, inclusive. The second end 747 of the curved portion 745 is located between the edge 799 of the second portion 72 and a point on the curved portion 745 that is located farthest from the edge 799 of the second portion 72 in the second direction. A virtual central angle of the curved portion 745, which is an arc, is greater than 90 degrees.

The separation line 742 includes a linear portion 744 and a curved portion 746. The linear portion 744 linearly extends from the edge 799 of the second portion 72 toward the edge 732 of the second portion 72 in the second direction. A first end of the curved portion 746 is connected to a distal end, which is spaced apart from the first one of the edges of the second portion 72, of the linear portion 744. The curved portion 746 extends from the distal end of the linear portion 744 in the clockwise direction in the bottom view while curving in an arc. A second end 748 of the curved portion 746 is located in the third portion 73. A radius of curvature of the curved portion 746 is within a range from 0.3 mm to 5 mm, inclusive. The radius of curvature of each of the curved portions 745, 746 is, for example, 0.5 mm. The second end 748 of the curved portion 746 is located between the edge 799 of the second portion 72 and a point on the curved portion 746 that is located farthest from the edge 799 of the second portion 72 in the second direction. A virtual central angle of the curved portion 746, which is an arc, is greater than 90 degrees.

A base material composite 750 shown in FIG. 21B includes a separation line 751 in place of the separation line 785. The base material composite 750 also includes a separation line 752 in place of the separation line 786.

The separation line 751 includes linear portions 753, 757 and a curved portion 755. The linear portion 753 linearly extends from the edge 799, which is the first one of the opposite edges 732, 799 of the second portion 72 in the second direction, toward the edge 732, which is the second one of the opposite edges 732, 799 of the second portion 72 in the second direction. A first end of the curved portion 755 is connected to a distal end, which is spaced apart from the first one of the edges of the second portion 72, of the linear portion 753. The curved portion 755 extends from the distal end of the linear portion 753 in the clockwise direction in the bottom view while curving in an arc. A second end of the curved portion 755 is located in the second portion 72. A radius of curvature of the curved portion 755 is within a range from 0.3 mm to 5 mm, inclusive. The linear portion 757 extends from the second end of the curved portion 755 toward the edge 799 of the second portion 72. The linear portion 757 is shorter than the linear portion 753.

The separation line 752 includes linear portions 754, 758 and a curved portion 756. The linear portion 754 linearly extends from the edge 799 of the second portion 72 toward the edge 732 of the second portion 72 in the second direction. A first end of the curved portion 756 is connected to a distal end, which is spaced apart from the first one of the edges of the second portion 72, of the linear portion 754. The curved portion 756 extends from the distal end of the linear portion 754 in the counterclockwise direction in the bottom view while curving in an arc. A radius of curvature of the curved portion 756 is within a range from 0.3 mm to 5 mm, inclusive. The radius of curvature of each of the curved portions 755, 756 is, for example, 0.5 mm. A second end of the curved portion 756 is located in the second portion 72. The linear portion 758 extends from the second end of the curved portion 756 toward the edge 799 of the second portion 72. The linear portion 758 is shorter than the linear portion 754.

A base material composite 760 shown in FIG. 21C includes a separation line 761 in place of the separation line 785. The base material composite 760 also includes a separation line 762 in place of the separation line 786.

The separation line 761 includes a linear portion 763 and a curved portion 765. A radius of curvature of the curved portion 765 is smaller than the radius of curvature of the curved portion 789 of the ninth modified embodiment. The separation line 762 includes a linear portion 764 and a curved portion 766. A radius of curvature of the curved portion 766 is smaller than the radius of curvature of the curved portion 790 of the ninth modified embodiment. The radius of curvature of each of the curved portions 765, 766 is within a range from 0.3 mm to 5 mm, inclusive, and, for example, 0.3 mm.

In the above-described embodiment, modified embodiments and further modifications, the mediums 6, 106, 206, 306, 406, 506, 606, 705, 706 and 906 are examples of a medium according to the present disclosure. The base materials 7, 207, 307, 407, 507, and 607 are examples of a base material according to the present disclosure. The release liners 9, 109, 209, 309, 409, 509 and 609 are examples of a release liner according to the present disclosure. The printing surfaces 69, 269, 369, 469, 569 and 669 are examples of a printing surface according to the present disclosure. The adhesive layer 70 is an example of an adhesive layer according to the present disclosure. The first portions 71, 271, 371, 471, 571 and 671 are examples of a first portion according to the present disclosure. The second portions 72, 272, 372, 472, 572 and 672 are examples of a second portion according to the present disclosure. The third portions 73, 273, 373, 473 and 573 are examples of a third portion according to the present disclosure.

Thus cuts 81 to 83, 87 to 89, 381 to 383 are examples of a cut according to the present disclosure. The first base materials 111, 211, 311, 411, 511, 611, 711 and 911 are examples of a first base material according to the present disclosure. The second base materials 112, 212, 312, 412, 512, 612, 712 and 912 are examples of a second base material according to the present disclosure. The base portions 275, 375, 475, 575, 675 and 721 are examples of a base portion according to the present disclosure. The fold portions 276, 376, 476, 576, 676 and 722 are examples of a first fold portion according to the present disclosure. The fold portion 377 is an example of a second fold portion according to the present disclosure. The recess 581 is an example of a recess according to the present disclosure. The fold line 640 is an example of a fold line according to the present disclosure. The separation lines 741, 751, 761 and 785 are examples of a separation line according to the present disclosure. The linear portions 743, 753, 763 and 787 are examples of a linear portion according to the present disclosure. The curved portions 745, 755, 765 and 789 are examples of a curved portion according to the present disclosure. The edges 731,733, 735 and 737 are examples of a first one of opposite edges of a base portion in a second direction according to the present disclosure. The edges 732,734, 736 and 738 are examples of a second one of opposite edges of a base portion in a second direction according to the present disclosure. The edge 799 is an example of a first one of opposite edges of a second portion in a second direction according to the present disclosure. The edges 732 and 800 are examples of a second one of opposite edges of a second portion in a second direction according to the present disclosure. The distal end 795 is an example of a distal end according to the present disclosure. The first end 797 is an example of a first end according to the present disclosure.

The medium 6 in the above-described embodiment includes the base materials 7, each having the printing surface 69 and the adhesive layer 70, and the release liner 9 affixed to the adhesive layers 70 of the base materials 7. The base materials 7 each have the first portion 71 and the second portion 72, which is aligned with the first portion 71 in the first direction and connected to the first portion 71. The second portion 72 includes the base portion 721 and the fold portion 722. The base portion 721 is aligned with the first portion 71 in the first direction and connected to the first portion 71. The fold portion 722 is aligned with the base portion 721 in the second direction, which is perpendicular to the first direction, and connected to the base portion 721. The base portion 721 is shorter than the first portion 71 in the second direction. The second portion 72 includes the cuts 81 to 83 that extends in the thickness direction of the base material 7. The cuts 81 to 83 contribute to reducing a restoring force of the second portion 72, which is disposed around an object with the base portion 721 and the fold portion 722 affixed together, as compared to the second portion 72 without any cut or recess. The cuts 81 to 83 of the second portion 72 of the medium 6 thus contribute to reducing a possibility that the affixed portions separate from each other due to the restoring force of the second portion 72 disposed around the object.

The cuts 81 to 83 are included either in the base portion 721 or the fold portion 722. The cuts 81 to 83 of the second portion 72 of the medium 6 contribute to securing strength of the second portion 72 while reducing the restoring force of the second portion 72, as compared to a medium that includes the cuts 81 to 83 in both of the base portion 721 and the fold portion 722.

The cuts 81 to 83 of the medium 6 extend through the base material 7 in the thickness direction. The cuts 81 to 83 make it easier for the user to cut the second portion 72 of the medium 6 disposed around an object with the base portion 721 and the fold portion 722 affixed together.

The recesses 581 of the medium 506 in the fifth modified embodiment does not extend through the base material 507. In other words, the depth of each of the recesses 581 is smaller than the thickness of the base material 507. The recesses 581 of the second portion 572 of the medium 506 contributes to reducing a possibility that the second portion 572, which is disposed around an object with the base portion 575 and the fold portion 576 affixed together, is unintentionally cut.

The longitudinal direction of each of the cuts 81 to 83 of the medium 6 is parallel to the second direction. The cuts 81 to 83 contribute to more effectively reducing the restoring force of the second portion 72 of the medium 6, which is disposed around an object with the base portion 721 and the fold portion 722 affixed together, as compared to a medium of a first comparative example. The medium of the first comparative embodiment includes at least one recess or at least one cut, whose longitudinal direction is parallel to the first direction.

The cut 82 of the medium 6 is at the center of the second portion 72 in the first direction. The second portion 72, which is disposed around an object with the base portion 721 and the fold portion 722 affixed together, is usually bent at a portion in the vicinity of the center of the second portion 72 in the first direction. The cut 82 of the second portion 72 of the medium 6 contributes to more effectively reducing the restoring force of the second portion 72, which is disposed around the object with the base portion 721 and the fold portion 722 affixed together, as compared to a medium of a second comparative embodiment. The medium of the second comparative embodiment includes at least one recess or at least one cut that is offset from or does not overlap the center of the second portion 72 in the first direction.

The medium 6 includes a plurality of cuts, i.e., the cuts 81 to 83, in the second portion 72. The cuts 81 to 83 of the medium 6 contribute to more effectively reducing the restoring force of the second portion 72, which is disposed around an object with the base portion 721 and the fold portion 722 affixed together, as compared to a medium including only one of the cuts 81 to 83.

The medium 406 of the fourth modified embodiment includes the cuts 87 to 89 whose longitudinal direction crosses the first direction and the second direction. The cuts 87 to 89 in the second portion 472 of the medium 406 contribute to ensuring the length of each of the cuts 87 to 89, as compared to a medium of a third comparative embodiment. The medium of the third comparative embodiment includes the cuts 87 to 89 that extend parallel to the first direction or the second direction.

The base material 7 of the medium 6 of the above-described embodiment includes the third portion 73 that is aligned with the second portion 72 in the first direction and connected to the second portion 72. The base portion 721 is shorter than the third portion 73 in the second direction. The second portion 72 is located between the first portion 71 and the third portion 73 in the first direction. The third portion 73 of the medium 6 makes it possible for the user to dispose the second portion 72, in which the base portion 721 and the fold portion 722 affixed together, around an object and then affix the first portion 71 and the third portion 73 to each other. The third portion 73 of the medium 6 thus facilitates the process of attaching the base material 7 to the object.

The first portion 671 of the medium 606 of the sixth modified embodiment includes the fold line 640 that passes the center of the first portion 671 in the second direction. The fold line 640 makes it easier for the user to fold the first portion 671 along the fold line 640 to affix the folded portions together.

The fold portion 722 of the medium 6 of the above-described embodiment is adjacent to the edge 731, which is the first one of the opposite edges 731, 732 of the base portion 721 in the second direction. The edge 732, which is the second one of the opposite edges 731, 732 of the base portion 721 in the second direction defines an edge of the second portion 72. The fold portion 722 of the medium 6 contributes to reducing labor of affixing the fold portion 722 to the base portion 721, as compared to a medium of a fourth comparative embodiment. The medium of the fourth comparative embodiment includes two fold portions, a first one of which is adjacent to the edge 731 of the base portion 721 in the second direction and a second one of which is adjacent to the edge 732 of the base portion 721 in the second direction. The fold portion 722 of the medium 6 contributes to reducing the restoring force of the second portion 72, as compared to the medium of the fourth comparative embodiment.

The fold portions 376, 377 of the medium 306 of the third modified embodiment are adjacent to the first one and the second one of the opposite edges 735, 736 of the base portion 375 in the second direction, respectively. The fold portions 376, 377 of the medium 306 contribute to enhancing the strength of the second portion 372, in which the fold portions 376, 377 are affixed to the base portion 375, as compared to a medium of a sixth comparative embodiment. The medium of the sixth comparative embodiment includes a fold portion that is adjacent to only one of the opposite edges 735, 736 of the base portion 375 in the second direction.

The medium 6 includes the release liner 9 and the base materials 7, including the first base material 111 and the second base material 112, that are affixed to the release liner 9. The first base material 111 is affixed to the release liner 9 such that the first base material 111 is in contact with the second base material 112. The medium 6 contributes to reducing a size of the release liner 9 that corresponds to one base material 7, as compared to a medium of a seventh comparative embodiment. The medium of the seventh comparative embodiment includes only one base material 7 that is affixed to the release liner 9, or includes the first base material 111 and the second base material 112 that are affixed to the release liner 9 while being spaced apart from each other.

The base portion 721 of the first base material 111 and the base portion 721 of the second base material 112 are disposed between the fold portion 722 of the first base material 111 and the fold portion 722 of the second base material 112 in the second direction. The medium 6 contributes to facilitating peeling the fold portion 722 of the first base material 111 and the fold portion 722 of the second base material 112 from the release liner 9, as compared to a medium of an eighth comparative embodiment. The medium of the eighth comparative embodiment includes the first base material 111 and the second base material 112, but the base portion 721 of either the first base material 111 or the second base material 112 is not, or the base portions 721 of both the first base material 111 and the second base material 112 are not between the fold portion 722 of the first base material 111 and the fold portion 722 of the second base material 112 in the second direction.

The longitudinal direction of the release liner 9 of the medium 6 is perpendicular to the first direction. The medium 6 contributes to reducing a possibility that the base materials 7 are bent in the first direction, as compared to a medium that includes the release liner 9 whose longitudinal direction is parallel to the first direction.

The length X8 of the fold portion 722 of the medium 6 is longer than the length X7 of the base portion 721 in the second direction. The base portion 721 of the medium 6 facilitates affixing the fold portion 722 to the base portion 721 such that the fold portion 722 covers the adhesive layer 70 of the base portion 721, as compared to a medium of a ninth comparative embodiment. In addition, the base portion 721 of the medium 6 contributes to reducing a possibility that the adhesive layer 70 is partly exposed and sticks to the object, with the fold portion 722 and the base portion 721 being affixed together. The medium of the ninth comparative embodiment includes the fold portion 722 that is shorter than the base portion 721 in the second direction.

The cuts 81 to 83 of the medium 6 are equally spaced in the first direction. The cuts 81 to 83 of the medium 6 contributes to stabilizing the shape of the second portion 72 that is disposed around the object, as compared to a medium with the cuts 81 to 83 that are not equally spaced.

The medium 6 is a tape that is wound into a roll. The medium 6 contributes to housing the medium 6 in a compact space without folding the medium 6, as compared to a medium that is not wound into a roll.

The medium 6 includes the base materials 7, each having the printing surface 69 and the adhesive layer 70, and the release liner 9 affixed to the adhesive layers 70 of the base materials 7. The base materials 7 each have the first portion 71 and the second portion 72, which is aligned with the first portion 71 in the first direction and connected to the first portion 71. The second portion 72 includes the base portion 721 and the fold portion 722. The base portion 721 is aligned with the first portion 71 in the first direction and connected to the first portion 71. The fold portion 722 is aligned with the base portion 721 in the second direction, which is perpendicular to the first direction, and connected to the base portion 721. The base portion 721 is shorter than the first portion 71 in the second direction. The second portion 72 has a lower rigidity than the first portion 71. The cuts 81 to 83 of the second portion 72 of the medium 6 contribute to reducing the restoring force of the second portion 72, which is disposed around an object with the base portion 721 and the fold portion 722 affixed together, as compared to a medium including a second portion without the cuts 81 to 83. The cuts 81 to 83 of the second portion 72 of the medium 6 thus contribute to reducing the possibility that the affixed portions separate from each other due to the restoring force of the second portion 72 disposed around the object.

The base material 707 of the medium 706 of the seventh modified embodiment includes the separation line 785 that separates the fold portion 722 and the first portion 71 in the first direction. The separation line 785 extends through the base material 707 in the thickness direction. The separation line includes the linear portion 787 and the curved portion 789. The linear portion 787 linearly extends from the edge 799, which is the first one of the opposite edges 732, 799 of the second portion 72 in the second direction, toward the edge 732, which is the second one of the opposite edges 732, 799 of the second portion 72. The curved portion 789 extends from the linear portion 787 in an arc. The first end 797 of the curved portion 789 is connected to the distal end 795 of the linear portion 787. The medium 706 of the seventh modified embodiment contributes to reducing a possibility that the base material 707 is torn between the first portion 71 and the base portion 721 of the second portion 72 when the base material 707 is peeled from the release liner 109, as compared to a medium with a linearly extending separation line.

The second end 791 of the curved portion 789 of the medium 706 of the seventh modified embodiment is located between the edge 799, which is the first one of the opposite edges 732, 799 of the second portion 72 in the second direction, and the point 793 on the curved portion 789 that is farthest from the edge 799 of the second portion 72 in the second direction. The medium 706 contributes to reducing the possibility that the base material 707 is torn between the first portion 71 and the base portion 721 of the second portion 72 when the base material 707 is peeled from the release liner 109, as compared to a medium including the curved portion 789 whose second end 791 is not located between the edge 799 and the point 793 on the curved portion 789 in the second direction.

The radius of curvature of the curved portion 789 of the medium 706 of the seventh modified embodiment is within the range from 0.3 mm to 5 mm, inclusive. The medium 706 contributes to reducing the possibility that the base material 707 is torn between the first portion 71 and the base portion 721 of the second portion 72 when the base material 707 is peeled from the release liner 109, as compared to a medium including the curved portion 789 whose radius of curvature is outside the range from 0.3 mm to 5 mm.

The second end 791 of the curved portion 789 of the medium 706 of the seventh modified embodiment is located in the second portion 72. The medium 706 contributes to reducing a possibility that the first portion 71 is torn when the base material 707 is peeled from the release liner 109, as compared to a medium including the curved portion 789 whose second end 791 is outside the second portion 72.

The second end of the curved portion 745 of the base material 707 is located in the first portion 71, as in the base material composite 740 of the medium 706 shown in FIG. 21A. The medium 706 contributes to reducing a possibility that the second portion 72 is torn when the base material 707 is peeled from the release liner 109, as compared to a medium including the curved portion 745 whose second end is outside the first portion 71.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The medium 6 may not be wound into the roll. Instead, the medium 6 may be continuous, folded paper. A medium without a third portion may be employed. The medium without the third portion may include a first portion having a rectangular shape that is elongated in the first direction. The medium may include a fold line that passes a center of the first portion in the first direction. A user of the medium having the fold line that passes the center of the first portion may fold the first portion of the medium at the center of the first portion in the first direction to affix an adhesive layer of a portion adjacent to one of opposite edges of the first portion to an adhesive layer of a portion adjacent to the other of the opposite edges of the first portion.

The color of the release liner 9 may be changed as appropriate. The marks 8 may be omitted from the release liner 9. Any of the conditions such as the shape, positions and color of the marks 8 may be changed, in accordance with the conditions of the sensor 50 such as the structure and position of the sensor 50.

The at least one recess or the at least one cut in the second portion may be disposed in the base portion but not in the fold portion. The second portion may include at least one recess and at least one cut. The recess or the cut in the second portion may or may not extend through the base material in the thickness direction. One or some or all of the recesses in the second portion may or may not extend through the base material in the thickness direction. One or some or all of the cuts in the second portion may or may not extend through the base material in the thickness direction. The shape of the recess and the shape of the cut in the second portion may be changed as appropriate. For example, the recess and the cut in the second portion may be wave-shaped, or zigzag.

The longitudinal direction of the cuts 81 to 83 may be parallel to the first direction. The medium 6 may not include a cut or a recess at the center of the second portion 72 in the first direction. The number, shape and size of the at least one recess or the at least one cut may be changed as appropriate. The second portion 72 may include only one recess or only one cut.

The base portion 721 may have the same length as the first portion 71 and the third portion 73 in the second direction. In a medium that includes a first portion and a second portion of which one of longitudinal edges is connected to the first portion but does not include a third portion, the first portion may be shorter than the second portion in the first direction. The medium 6 may include only one base material affixed to the release liner 9. The first base material 111 may be in contact with the second base material 112 in the first direction. The first base material 111 may be spaced apart from the second base material 112 in the second direction. The base material composite may include three or more base materials.

The base material composite may include a blank space that surrounds the base materials, or may not include any blank space. The medium may include a blank space between adjacent base material composites. A blank space may fill the recess 723 of the base material 7 so that the release liner 9 is not exposed, i.e., the release liner 9 is covered by the blank space in the recess 723.

The fold portion 722 of the first base material 111 and the fold portion 722 of the second base material 112 may be disposed between the base portion 721 of the first base material 111 and the base portion 721 of the second base material 112 in the second direction of the second portion 72 of the medium 6. The base portion 721 of the first base material 111, the fold portion 722 of the first base material 111, the base portion 721 of the second base material 112 and the fold portion 722 of the second base material 112 may be aligned in this order in the second direction of the second portion 72 of the medium 6.

The longitudinal direction of the release liner 9 of the medium 6 may or may not cross the first direction. The length X8 of the fold portion 722 of the medium 6 in the second direction may be equal to or less than the length X7 of the base portion 721 in the second direction. The cuts 81 to 83 may not be equally spaced in the first direction.

Each of the cuts 85, 86 may be a perforated line, or may be a cut that does not extend through the base material 7 in the thickness direction, i.e., whose depth is smaller than the thickness of the base material 7. A user of a medium with the cut 85 that does not extend through the base material 7 in the thickness direction may cut the base material 7 along the cut 85 between the first portion 71 and the fold portion 722. A user of a medium with the cut 86 that does not extend through the base material 7 in the thickness direction may cut the base material 7 along the cut 86 between the third portion 73 and the fold portion 722.

The fold line 640 of the medium 606 may be omitted. The fold line 640 may be a cut that does not extend through the first portion 671 in the thickness direction. The medium 606 may include, in place of the cut 85, or the separation line 785, 741, 751 or 761.

In order to make the rigidity of the second portion 72 of the medium 6 to be lower than the rigidity of the first portion 71, any one or more of the following methods may be employed, for example. At least one recess or at least one cut may be disposed in the second portion 72. The thickness of the second portion 72 may be made smaller than the thickness of the first portion 71 and the thickness of the third portion 73. The second portion 72 may be formed by a material that is different from the first portion 71 and the third portion 73.

The virtual central angle of the curved portion 789 may be changed as appropriate. The second end 791 of the curved portion 789 may not be located between the edge 799 of the second portion 72, i.e., the first one of the opposite edges of the second portion 72 in the second direction, and the point 793 on the curved portion 789 that is farthest from the edge 799 in the second direction. The radius of curvature of the curved portion 789 may be outside the range from 0.3 mm to 5 mm. The separation lines 785, 786 of the medium 706 may be curved in the same direction. The radius of curvature of the separation line 785 and the radius of curvature of the separation line 786 may be the same, or may be different from each other. The medium 706 may include, in place of the separation line 786, the cut 86, the separation line 742, the separation line 752 or the separation line 762. The medium 706 may include, in place of the separation line 785, the cut 85, the separation line 741, the separation line 751 or the separation line 761.

The above-described embodiment and modified examples may be combined as appropriate insofar as no contradictions arise. In addition to combinations exemplified in the scope of the claims herein, the applicants of the present application have an intention to acquire the patent rights for other combined aspects insofar as they do not depart from the scope and gist of the present disclosure, and insofar as no contradictions arise.

What is claimed is:

1. A medium, comprising:
at least one base material including a printing surface and an adhesive layer; and
a release liner affixed to the adhesive layer,
wherein
the at least one base material includes a first portion and a second portion,
the second portion is aligned with the first portion in a first direction and connected to the first portion,
the second portion includes a base portion and a first fold portion,
the base portion is aligned with the first portion in the first direction and connected to the first portion,
the first fold portion is aligned with the base portion in a second direction, which is perpendicular to the first direction, and connected to the base portion,
the base portion is shorter than the first portion in the second direction, and
the second portion includes at least one recess recessed in a thickness direction of the least one base material or at least one cut extending in the thickness direction.

2. The medium according to claim 1, wherein the at least one recess or the at least one cut is included in the base portion or the first fold portion.

3. The medium according to claim 1, wherein the at least one recess or the at least one cut extends through the least one base material in the thickness direction.

4. The medium according to claim 1, wherein a depth of the at least one recess or the at least one cut in the thickness direction is smaller than a thickness of the least one base material.

5. The medium according to claim 1, wherein a longitudinal direction of the at least one recess or the at least one cut is parallel to the second direction.

6. The medium according to claim 5, wherein the at least one recess or the at least one cut is disposed at a center of the second portion in the first direction.

7. The medium according to claim 6, wherein the at least one recess or the at least one cut includes a plurality of recesses or a plurality of cuts disposed in the second portion.

8. The medium according to claim 1, wherein a longitudinal direction of the at least one recess or the at least one cut crosses the first direction and the second direction.

9. The medium according to claim 1, wherein
the at least one base material further includes a third portion aligned with the second portion in the first direction and connected to the second portion,
the base portion of the second portion is shorter than the third portion in the second direction, and
the second portion is located between the first portion and the third portion in the first direction.

10. The medium according to claim 1, wherein the first portion includes a fold line that passes a center of the first portion in the second direction.

11. The medium according to claim 1, wherein
the first fold portion is adjacent to a first one of opposite edges of the base portion in the second direction, the opposite edges of the base portion being opposite from each other in the second direction, and
a second one of the opposite edges of the base portion in the second direction defines an edge of the second portion.

12. The medium according to claim 1, wherein
the second portion further includes a second fold portion,
the first fold portion is adjacent to a first one of opposite edges of the base portion in the second direction, the opposite edges of the base portion being opposite from each other in the second direction, and
the second fold portion is adjacent to a second one of the opposite edges of the base portion in the second direction.

13. The medium according to claim 1, wherein
the at least one base material includes a plurality of base materials affixed to the release liner, and
the plurality of base materials include a first base material and a second base material that are in contact with each other.

14. The medium according to claim 13, wherein the base portion of the first base material and the base portion of the second base material are disposed between the first fold portion of the first base material and the first fold portion of the second base material in the second direction.

15. The medium according to claim 13, wherein a longitudinal direction of the release liner is perpendicular to the first direction.

16. The medium according to claim 13, wherein the first fold portion is longer than the base portion in the second direction.

17. The medium according to claim 1, wherein at least one cut or the at least one recess in the second portion includes a plurality of cuts or a plurality of recesses equally spaced in the first direction.

18. The medium according to claim 13, wherein the medium is a tape that is wound into a roll.

19. A medium, comprising:
a base material including a printing surface and an adhesive layer; and
a release liner affixed to the adhesive layer,
wherein
the base material includes a first portion and a second portion,
the second portion is aligned with the first portion in a first direction and connected to the first portion,
the second portion includes a base portion and a fold portion,
the base portion is aligned with the first portion in the first direction and connected to the first portion,
the fold portion is aligned with the base portion in a second direction, which is perpendicular to the first direction, and connected to the base portion,
the base portion is shorter than the first portion in the second direction, and
the second portion has a lower rigidity than the first portion.

20. The medium according to claim 1, wherein
the at least one base material includes a separation line that separates the first fold portion and the first portion in the first direction,
the separation line extends through the at least one base material in the thickness direction,
the separation line includes (i) a linear portion linearly extending from a first one of opposite edges of the second portion toward a second one of the opposite edges of the second portion, the opposite edges of the second portion being opposite from each other in the second direction, and (ii) a curved portion extending from the linear portion in an arc,
the linear portion has a distal end spaced apart from the first one of the opposite edges of the second portion in the second direction, and
the curved portion has a first end and a second end, the first end being opposite to the second end, the first end being connected to the distal end of the linear portion.
